(19) United States
(12) Patent Application Publication
(10) Pub. No.: US 2016/0264397 A1
(43) Pub. Date: Sep. 15, 2016

(54) METHOD AND EQUIPMENT FOR THE DISASSEMBLY OF MATRESSES

(71) Applicant: RTM Recycling Systems B.V., Nieuwerbrug Aan Den Rijn (NL)

(72) Inventors: Rob Wagenaar, Biddinghuizen (NL); Gerrit Lambertus Wagenaar, Beddinghuizen (NL); Jeroen Wagenaar, Elburg (NL); Robert Wagenaar, Biddinghuizen (NL); Johannes Verbakel, Altona North (AU)

(21) Appl. No.: 15/165,049

(22) Filed: May 26, 2016

Related U.S. Application Data
(63) Continuation-in-part of application No. PCT/NL2014/050808, filed on Nov. 28, 2014.

(30) Foreign Application Priority Data
Nov. 29, 2013 (NL) 2011861
Feb. 10, 2016 (AU) 2016900433

(51) Int. Cl. B68G 15/00; B26D 3/28

(52) U.S. Cl. CPC B68G 15/00; B26D 3/282

(57) ABSTRACT

An apparatus to disassemble a mattress, the mattress including a mattress core between a top ticking and a bottom ticking and the mattress having perimeter surfaces comprising a pair of opposing side surfaces extending in a longitudinal direction and a pair of opposing end surfaces extending between the opposing side surfaces, the apparatus including: a cutting arrangement for applying at least one cut along a length of at least one of the perimeter surfaces; and at least one peeling roller having a peeling surface with retractable pins for engaging with the top and/or bottom ticking, the retractable pins being movable between a retracted position and an extended position, wherein the at least one peeling roller is rotatable in a peeling direction for peeling the top and/or bottom ticking from the mattress with the pins in the extended position and wherein the at least one peeling roller is rotatable in a removal direction, opposite to the peeling direction, for removing the peeled ticking from the peeling surface with the pins in the retracted position.

### TECHNICAL FIELD

The present invention relates generally to a method and an apparatus for disassembling a mattress to facilitate recycling of the constituent materials. In particular, the invention concerns a method of removing the outer layer of a mattress in a typically early stage of a mattress recycling process. However, it is to be appreciated that the invention could be applied in other aspects or stages of a mattress recycling process.

### BACKGROUND OF INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Typical mattresses are constructed using a variety of materials, many of which are suitable for recycling the end of the mattresses' usable life. In addition to avoiding the creation of undesirable landfill, the recycling of unserviceable or unwanted mattresses provides an opportunity to recover valuable constituent materials which can be sold for new applications.

In general terms, mattresses can be divided into two categories, those with internal metal springs and those without. Mattresses having internal metal springs consist, typically, of an inner core of metal springs or coils to provide support for a sleeper's body. The inner core is surrounded by several layers of upholstery usually including a layer of felt padding and at least one layer of foam, for example polyurethane foam, to provide cushioning and additional support. The outer layer of mattress upholstery is generally formed by a durable textile known as ticking which surrounds the inner upholstery and springs. In many instances, this outer layer is formed of a multi-layered quilt including a central layer of foam wadding. Additional materials such as timber, plastic stiffeners, latex rubber or fibrous padding may also be included, many of these materials also being suitable for recycling.

The alternative category of mattresses is those which do not have an internal spring core. These alternative types of mattresses such as latex or fully-foam mattresses may not have a spring inner core but are nonetheless desirable for recycling purposes. In this regard, non-spring mattresses can undergo a somewhat simplified recycling process because the process step of separating the metal spring core from the remaining upholstery and cushioning is obviated.

Unwanted or discarded mattresses therefore provide an attractive source of recyclables, provided that the mattresses can be disassembled and separated into constituent materials before distribution. In either category of the above categories of mattress core, the first step in a mattress recycling process will often be the removal of the outermost layer of upholstery known as ticking or quilting. Whilst mattresses can be manually dissembled with a cutting instrument such as shears, pliers or other cutters, the introduction of manual labour into a recycling process line is generally undesirable in terms of safety, for example, due to the high levels of dust expelled during the recycling process and also the potential for repetitive strain injuries. Moreover, manual mattress disassembly is time consuming and inefficient in terms of labour cost per unit of recovered material.

It is therefore desirable to provide an improved or alternate method or device to facilitate mattress disassembly in an efficient and timely manner.

### SUMMARY OF INVENTION

It is to be understood that spatial references throughout the specification are generally based upon and reference to a conventional sleeping mattress of the type that will be readily appreciated by a person skilled in the art. On this basis, terms such as a mattress “sleeping surface” will be appreciated as the largest surface of the mattress and this surface being a generally rectangular surface. Similarly, terms such as “lengthwise” or “longitudinal axis” will be appreciated as referring to the direction extending between the head and the foot of a mattress. It will also be appreciated that spatial references to “top” and “bottom” will be understood with reference to a mattress lying flat in its conventional orientation with one of the sleeping surfaces facing downwards and the other sleeping surface facing upwards.

According to the present invention, there is provided an apparatus to disassemble a mattress, the mattress including a mattress core between a top ticking and a bottom ticking and the mattress having perimeter surfaces comprising a pair of opposing side surfaces extending in a longitudinal direction and a pair of opposing end surfaces extending between the opposing side surfaces, the apparatus including: a cutting arrangement for applying at least one cut along a length of at least one of the perimeter surfaces; and at least one peeling roller having a peeling surface with retractable pins for engaging with the top and/or bottom ticking, the retractable pins being movable between a retracted position and an extended position, wherein the at least one peeling roller is rotatable in a peeling direction for peeling the top and/or bottom ticking from the mattress with the pins in the extended position and wherein the at least one peeling roller is rotatable in a removal direction, opposite to the peeling direction, for removing the peeled ticking from the peeling surface with the pins in the retracted position.

The present invention therefore provides an apparatus which can advantageously disassemble a mattress to allow constituent elements to be separated and sorted for recycling purposes. By way of example, ticking removed from the mattress core by an apparatus of the present invention may contain cotton which can be subsequently sorted and baled for transport for subsequent recycled application in the textile industry. Similarly, the polyurethane exposed by removal of the external ticking can have a variety of uses, in particular as recycled carpet underlay. Moreover, the removal of external mattress ticking exposes the mattress core which, in the case of a foam core, may be subsequently cut into smaller portions and baled for subsequent recycling applications. In the case of a metal mattress core, the exposed core can now be conveniently stripped of any padding or cushioning beneath between the ticking and the core before being conveyed to a metal shredding device and pressed into shredded steel bales for transport.

Advantageously, the present invention employs mechanical processes to at least partially automate the disassembly process. By way of explanation, mattress first undergoes a cutting step performed by the cutting arrangement where at least one of the perimeter surfaces of the mattress is cut to separate or substantially loosen the connection between the mattress ticking and the mattress core. In the next stage, the mattress is engaged by a peeling roller with pins that engaged the partially severed mattress ticking and thusly peel the ticking away from the mattress core. In a final step, the direction of the peeling roller is reversed in order to remove the peeled ticking from the peeling roller for subsequent recycling and to clear the peeling roller for the next mattress in the process line. It will thusly be appreciated that the present invention facilitates efficient recovery of the above materials due to the apparatus of the invention eliminating the need for manual cutting/removal of the mattress ticking using hand implements such as shears or knives.

In some forms of the present invention, the pins of the peeling roller are curved to facilitate engagement with the mattress ticking. This form of the invention is advantageous with particular mattress ticking that is more securely bound to the mattress core than other mattresses. In particular, certain types of mattress (typically those having metal cores) may include internal stapling elements known as hog rings which provide an additional connection between the ticking and the remainder of the mattress. In processing such mattresses, it may be desirable to utilise curved pins having a greater capacity to grip and peel ticking away from a mattress core. In some forms, the pins may therefore have a curve in a circumferential direction of the peeling roller so as to point in the direction of roller rotation when the mattress is fed into the at least one peeling roller. The increased ticking engagement is due to curved pins penetrating in an angled direction, relative to the mattress surface, into the mattress ticking. The result being that ticking is more securely engaged to the surface of the peeling rollers and less likely to slip off the pins as they rotate away from the mattress core. In an alternative form of the invention, the pins are straight but are angled in the direction of peeling roller rotation during the peeling stage.

In another form of the invention, the peeling roller includes a plurality of pin actuators to actuate movement of the pins between the extended and retracted positions, each pin actuator being associated with at least one pin. Advantageously, this form of the invention facilitates some degree of independent control over the movement of pins on the peeling roller. Accordingly, in a particular form of the invention, the plurality of pin actuators are independently operable to facilitate movement of pins on a section of the peeling surface that is independent from movement of pins on a separate section of the peeling surface.

The above form of the invention is advantageous in that a particular sequence of pin movement may be adopted to facilitate the peeling process. By way of example in some embodiments of the invention, the pins on the at least one peeling roller may be retracted at a particular point of the rotation so as to disengage with the mattress ticking. By way of example, it may be desirable in certain embodiments of the invention for the pins to retract at a point of rotation when they are oppositely disposed (i.e. 180°) from the portion of the roller in contact with the mattress. In particular forms of the invention, this may allow for the peeled ticking to be selectively directed away from the peeling roller under the influence of gravity or, alternatively, another roller such as a guiding roller.

An embodiment of the present invention can include a top peeling roller for removing the top ticking of the mattress and a bottom peeling roller for removing the bottom ticking of the mattress, the bottom peeling roller including a plurality of independently operable pin actuators facilitating movement of pins on a section of the bottom roller peeling surface that is independent from movement of the pins on a separate section of the bottom peeling roller peeling surface. Each of the top and bottom peeling rollers can be rotatable in a peeling direction for peeling the top and bottom ticking from the mattress respectively, the top peeling roller being rotatable in a removal direction opposite to the peeling direction for removing the peeled ticking from the top peeling roller peeling surface with the top roller pins in the retracted position and wherein the independent pin movement of the bottom roller facilitates the bottom peeling roller and the bottom ticking engaging at a first section of the bottom peeling roller peeling surface and concurrently disengaging at a second section of the bottom peeling roller peeling surface. In some embodiments of the present invention, the pins on the bottom peeling roller are configured to extend on one side of the bottom peeling roller and to concurrently retract at approximately the opposite side of the bottom peeling roller.

It will be appreciated that the present invention is intended for application to a wide variety of mattresses. In this regard, the Applicants have discovered during testing that mattresses from particular regions of the world exhibit certain construction characteristics which are seldom encountered in other regions. By way of example and as noted above, internal connective elements such as metal hog rings are frequently used in the construction of Australian and New Zealand mattresses whereas European originating mattresses seldom include such components. For this reason, in some forms of the invention it may be desirable to provide pins configured for increased engagement with the mattress ticking. One such example is the curved pin configuration discussed above. Another example is to provide pins having increased length to provide a deeper penetration with the mattress ticking and therefore greater engagement therewith.

In another embodiment of the present invention, the cutting arrangement includes a saw having at least one cutting element. This form of the invention may therefore employ a cutting saw to apply the cut to the perimeter surface of the mattress. In this regard, a cutting ‘saw’ refers to a cutting device with an associated cutting element having a toothed surface, for example a rotary saw, jig saw, chainsaw or other cutting device with an associated toothed cutting element. Of course, alternative cutting arrangements other than saw-type devices are envisioned and may instead include, for example, a fluid cutter such as a high pressure water jet cutter. Alternatively, the cutting arrangement could utilise a non-toothed cutting element such as a cutter with a sharpened slicing disc.

In certain forms, the saw of the above embodiment includes a plurality of cutting elements. As noted earlier, during testing and development of the present invention the Applicants have identified discrepancies between mattress constructions based on geographical origin. In this regard, certain mattresses, for example those which include internal hog ring connective elements may require a saw having a number of cutting elements to sufficiently free the mattress ticking from the mattress core so as to facilitate removal of the ticking in the subsequent peeling stage. Advantageously, providing a saw with a plurality of cutting elements necessarily produces a plurality of cuts on the perimeter surface of the mattress and, thusly, provides a significantly improve likelihood of severing the mattress ticking from any internal connective elements.

In one form of the invention, the saw is mounted to the free end of a pivotable cutting arm. Advantageously, the cutting arm may be biased to a normal position such that the conveyed mattress will contact the saw and cause the cutting arm to swing around the perimeter surface of the mattress whilst the saw is maintained in contact with the perimeter surface due to the bias in the cutting arm.

In particular forms of the invention, the plurality of cutting elements includes between three and eight cutting elements, preferably between four and seven cutting elements and more preferably six cutting elements. In this regard, the Applicants have successfully tested a multi blade saw having six cutting elements. It is noted that the number of cutting elements may be limited by the subsequent decrease in spacing between each cutting elements due to the amount of cutting debris being funneled through the spaces. Moreover, it will be appreciated that the pressure of the saw against the perimeter surface of the mattress is generally constant such that an increase in cutting elements causes a corresponding decrease in the force applied to each cutting element against the mattress perimeter surface. For this reason, the efficiency of the cutting arrangement will begin to diminish at a certain number of cutting elements and, thusly, the Applicants have identified an optimum range of between three and eight cutting elements.

Turning now to the specific arrangement of the saw and the cutting elements, in a particular embodiment of the invention, the plurality of cutting elements are axially spaced apart on the saw body. Accordingly, in some forms, each cutting element is positioned above or below an adjacent cutting element on the saw body. These forms of the invention advantageously provide that a plurality of cuts will be applied across the thickness of the mattress between the top and bottom ticking thereby further increasing the likelihood of severing or partially separating the ticking from the mattress core.

In a particular form of the above described embodiment, the saw includes a rotatable saw body wherein the cutting elements are cutting blades mounted to the rotatable saw body. In this form, a conventional rotary saw is utilised with cutting rotatable cutting blades mounted thereto. In alternative forms of the invention, the saw may be formed by a bandsaw. In still further alternatives, the saw may include a chainsaw arrangement. It will be appreciated that a person skilled in the art may readily envisage alternative forms of cutting arrangements which are encompassed by the scope of the present invention.

In another embodiment of the invention, there is provided a pair of saws arranged to cooperatively apply a cut along a length of the at least one perimeter surface. In this regard, the cutting arrangement may employ two or more separate saws to perform the cutting function. Advantageously, this form of the invention increases the speed at which the cutting stage can be performed by enabling the cutting to be shared by more than one saw. The cutting on the mattress perimeter surface may thusly be divided into separate sections which can each be performed by a separate saw.

In a further form of the invention, the apparatus may include a corner cutter for applying a cut to at least one corner of the mattress, the cut extending at least partially between the top and bottom ticking. This form of the invention facilitates a cut to be applied at least one corner of the mattress i.e. the point at which of the opposing side surfaces meets one of the opposing end surfaces. Advantageously, applying a cut at a corner of the mattress has been found to reduce the tension in the outer layers of mattress quilting or ticking thereby further facilitating removal of the ticking in the subsequent peeling stage. In some forms, the corner cutter may apply a generally vertical cut which extends between the top and the bottom ticking. In other forms, the corner cut may only extend partially between the top and the bottom ticking. It will be appreciated that the precise orientation or length of the corner cut may vary between mattresses so long as the cut is suitable for at least partially relieving the inherent tension or tautness in the outer layers of the mattress.

In another embodiment of the invention, the position of the at least one peeling roller is adjustable. As noted above, the present invention is intended for application to a variety of mattress types and sizes. Accordingly, this form of the invention advantageously enables for the position of the peeling roller, relative to the mattress, to be adjusted to thereby facilitate optimisation of the engagement between the pins and the mattress ticking. By way of example, it may be desirable when processing a thicker mattress to adjust the position of the peeling roller in order to accommodate the increased mattress size in the peeling stage. Similarly, when processing a particularly thin mattress it may be desirable to adjust the peeling roller closer to the mattress surface to improve engagement between the pins and the mattress ticking. In addition to the advantages noted above, the Applicant has determined that where an apparatus includes pair of peeling rollers, an adjustment of the bottom peeling roller to a level above the infeed conveyor may result in a better engagement with the mattress ticking.

In addition to adjustment of peeling roller position, in some forms of the invention it may be desirable to adjust the rotational speed of the peeling roller. In embodiments of the invention utilising a pair of peeling rollers, it may be advantageous to adjust the rotational speed of each roller independently to provide particular operational parameters for specific types of mattresses. In this regard, the method according to the present invention may include selectively determining the rotational speed of the peeling roller according to structural or dimensional parameter of a particular mattress.

In a particular form of the above-described embodiment, the apparatus includes a sensor and a controllable actuator to adjust the position of the at least one peeling roller into an engagement position based on the position and/or dimensions of the mattress determined by the sensor. As discussed in the background to the invention, in many instances it is desirable to automate the mattress disassembly process insofar as possible for the purposes of efficiency and/or safety. This form of the invention advantageously allows for an adjustment of the peeling roller position to be automated according to mattress data determined by a sensor. In some forms, the sensor may be an ultrasonic distance sensor. In alternative forms, the sensor may include a laser or infrared device. In still further forms, the sensor could comprise a mechanical limit switch, for example, an actuator in physical contact with a surface of the mattress and arranged to switch or trigger an adjustment of the apparatus depending on the position or nature of contact made upon the actuator by the mattress.

Notwithstanding the above advantages of an automated adjustment process, in an alternative form of the invention, there is provided a manually operable adjustment mechanism to adjust the height of the at least one peeling roller. In some applications, the automated adjustment mechanism discussed above may not be necessary where mattresses of a consistent size are being processed. In this regard a manually operable adjustment mechanism enables operators to configure the apparatus for a particular mattress size and then adjust the configuration if and when necessary to process mattresses having a different size. Moreover, a manually operable adjustment mechanism provides a reliable backup in the event of any technical problems with a more complex, automated system. In some forms of this embodiment, a manually operable adjustment mechanism may take the form of a hand crank or handle in operative association with a lead screw connected to the at least one peeling roller. In this form, rotation of the crank or handle will operate to adjust the position of the peeling roller as desired. Of course, it will be appreciated that a person skilled in the art may readily conceive of alternative manually operable adjustment mechanisms which fall within the scope of the present invention.

In a further embodiment of the present invention, the apparatus includes a conveyor for conveying the mattress through the cutting arrangement wherein the conveyor includes a plurality of friction portions for restricting movement of the mattress relative to the conveyer. Advantageously, friction portions reduce the likelihood of the mattress shifting on the conveyor throughout the disassembly process and, in particular, during the application of the cut to the mattress perimeter surface by the cutting arrangement. It will be appreciated that movement of the mattress during the cutting stage is generally undesirable as it may cause the cut to be discontinuous and therefore reduce the severance of the outer mattress layers from the mattress core. In a particular form of this embodiment, the friction portions comprise projection portions. Advantageously, the projection portions provide a high friction surface which greatly restricts potential movement on the mattress thereon. In alternative embodiments, the friction portions may consist of a series of spiked portions. In still further alternatives, the friction portions may be formed by a partially adhesive conveyor surface.

For similar reasons as discussed above for which friction portions are desirable, in another form of the invention, the apparatus may include a conveyor for conveying the mattress on a conveyor surface through the cutting mechanism wherein the apparatus further includes an overhead roller located above the conveyor for facilitating movement of the mattress through the cutting mechanism and for restricting movement of the mattress relative to the conveyor surface. In this form of the invention, potential movement of the mattress on the conveyor is arrested or at least reduced by the overhead rollers exerting a downward force on the mattress thereby increasing the frictional engagement between the underside of the mattress and the conveyor. In a further form of the invention, the overhead rollers may be provided in addition to the friction portions discussed above.

The apparatus of the present invention may also include at least one row of guiding rollers positioned adjacent to the at least one peeling roller for guiding a portion of peeled ticking toward the peeling surface to facilitate engagement of the pins with the top and/or bottom ticking. In this form, the guiding rollers advantageously guide the free end of the peeled ticking toward the peeling roller thereby increasing engagement between the pins and the ticking. In some forms, the guiding rollers may be positioned so as to facilitate engagement by exerting a pressure on the ticking. In alternative forms, the guiding rollers may be positioned so as to prevent the free end of the ticking from moving apart from the peeling roller but not sufficiently close such that a pressure is directly exerted on the ticking. In still further embodiments, an adjustment mechanism may be provided to adjust the position of the guiding rollers depending so as to, for example, facilitate engagement between the pins and the ticking during the peeling stage and allowing the guiding rollers to be re-positioned to increase clearance when the peeling roller direction is reversed to disengage the ticking from the peeling roller. In certain forms of the invention, the guiding rollers may be formed by an elastic material. In a particular form, the guiding rollers may be formed of rubber.

In some forms of the invention, the peeling roller may have a diameter between 400 mm to 500 mm. As noted above, in processing mattresses with internal connective elements or otherwise strongly connected external ticking, it may be desirable to utilise pins of increased length so as to increase the engagement between peeling rollers and the mattress ticking. In this regard, a peeling roller of sufficient diameter is required to house the larger pins. To this end, the Applicant has identified a preferred peeling roller diameter of 400-500 mm. In addition to accommodating pins of increased size, providing a peeling roller having this increased diameter (as compared with the Applicant's earlier apparatus′) allows for easier access to the roller interior thereby allowing for simpler maintenance and installation. Moreover, the Applicant has determined that using a peeling roller of this increased diameter provides a smoother and a larger pulling force for the improved peeling of larger mattresses.

In a particular form of the invention, the apparatus includes a top peeling roller and a bottom peeling roller, the peeling rollers being spaced apart to receive a mattress therebetween and wherein the top peeling roller and bottom peeling roller are positioned for engaging and removing the top ticking and the bottom ticking respectively. In this form of the invention, a pair of peeling rollers is provided to simultaneously engage with the top and bottom ticking of the mattress and thereby peel ticking from both top and bottom sides of the mattress concurrently. Moreover, the provision of a pair of peeling rollers advantageously increases engagement between the pins and mattress ticking due to the force being applied on each side of the mattress. Of course, depending on the particular recycling application and/or the type of mattress being processed, in other forms of the invention, mattress ticking is removed from one side only. This could be achieved with an apparatus according to the present invention which included only a single peeling roller. Alternatively, this could be achieved using a pair of peeling rollers but by activating the retractable pins on only one of the pair of peeling rollers.

According to the present invention, there is also provided a method of disassembling a mattress, the mattress including a mattress core between a top ticking and a bottom ticking and the mattress having a perimeter comprising a pair of opposing side surfaces extending in a longitudinal direction and a pair of opposing end surfaces extending between the opposing side surfaces, the method including: applying at least one cut along a length of at least one of the perimeter surfaces; feeding the mattress, in a cut-first orientation, into at least one rotating peeling roller, the at least one peeling roller having a peeling surface with retractable pins movable between a retracted position and an extended position; moving the pins of the at least one peeling roller to their extended position during the feeding of the mattress into the at least one peeling roller to engage and remove at least one of the top or bottom ticking of the mattress; and moving the pins of the at least one peeling roller to their retracted position and reversing the direction of rotation of the at least one peeling roller to disengage the ticking from the at least one peeling roller for subsequent removal.

The above method advantageously provides for efficient recovery of mattress constituent materials for the reasons discussed above in reference to the mattress disassembly apparatus. It will also be appreciated that while the above method may be performed by the apparatus discussed earlier there may be alternative devices also suitable for performing the above disassembly method.

In one form of the above method, during rotation of the at least one peeling roller, the movement of the pins toward a retracted or an extended position occurs separately on a first section of the peeling surface from the movement of the pins on a second section of the peeling surface. In a further form of the above method, during feeding of the mattress, at least some of the pins are moved so as to extend partially between their retracted position and their extended position. With reference to the various advantages of semi-independent pin retraction control discussed above, this form of the present invention advantageously enables greater control over the pin movement thereby facilitating specific sequences of pin movement which may improve the ticking engagement and ticking disengagement steps of the peeling roller process.

In another form of the above-described method of disassembling a mattress, the mattress is fed between a top peeling roller and a bottom peeling roller to remove the top and bottom ticking of a mattress respectively. As noted above, the cooperation of a pair of rollers facilitates simultaneous removal of the top and bottom mattress ticking thereby improving overall efficiency of the mattress disassembly process.

In another form of the above method, the at least one cut is applied to one of the side surfaces and to each of the end surfaces. In this form, a more extensive cut is applied to the mattress in order to increase the severance of mattress ticking from mattress core, prior to the mattress entering the ticking peeling stage. In this regard, applying a cut to three of the mattress perimeter surfaces forms a U-shaped cut which thereby improves the efficiency of the subsequent peeling step.

In one form of the present invention, the at least one perimeter surface includes a lengthwise direction extending between two corners of the mattress and a thickness direction, perpendicular to the lengthwise direction, extending between the top and bottom ticking, wherein a plurality of cuts is applied to the at least one perimeter surface in a lengthwise direction, each cut in the plurality of cuts being spaced apart from an adjacent cut in the thickness direction. In this form, the method of the present invention advantageously applies a number of cuts to the mattress perimeter surface thereby increasingly the severance of mattress ticking or quilting from the mattress core. As noted above, this method is particularly advantageously when processing mattresses having internal connective elements such as hog rings which provide points of additional connection between the mattress ticking and the mattress core that may be missed where only a single cut is applied to the mattress perimeter surfaces. In a particular embodiment of this form, the plurality of cuts are applied the at least one perimeter surface are parallel.

In another form the above method of disassembling a mattress includes the step of applying a corner cut to at least one corner of the mattress on the mattress perimeter. With reference to the advantages conveyed by the corner cut apparatus above, it will be appreciated that the step of applying cuts to a corner of the mattresses releases the tension or inherent tautness of the outer mattress textile or ticking thereby facilitating its subsequent removal in the peeling stage. In particular forms, the corner cut may extend at least partially between the top and bottom ticking. In alternative forms, the corner cut may extend continuously between the top and bottom ticking.

In a further embodiment, the at least one cut is applied by a cutting arrangement and the method further including the steps of: using a sensor to determine the position and/or dimensions of the mattress; and adjusting the position of the at least one peeling roller and/or the position of the cutting arrangement based on the determined position and/or dimensions of the mattress. Advantageously, this form enables optimisation of the method of mattress disassembly by automatically adjusting the position of the peeling roller for optimum engagement with the mattress ticking. In some forms of this embodiment, an ultrasonic distance sensor may be utilised.

In an alternative embodiment of the present invention there is provided a method for a mattress that has a mattress core between a top ticking and bottom ticking wherein: a cut is applied along at least one length; after which the mattress with the cut facing forward is fed in to a rotating top and/or bottom roller with retractable pins fitted to the circumference of these rollers during which whilst the mattress is moving forward the extended pins remove the top and/or bottom ticking which then is wrapped around the top and/or bottom roller and whilst the pins are retracted in the rollers the bottom and/or top ticking is unwrapped from the rollers when their rotation is reversed.

In another form, during the rotation of the rollers the pins, at least over a section of the rollers circumference, can extend or retract.

In another form of the above method, during the forward feeding of the mattress, for at least a section of the rollers circumference, the pins can extend completely or partially to engage with the top ticking and/or the bottom ticking.

In a further form, the top ticking is removed over the top of a top roller and/or the bottom ticking is removed along the bottom of a bottom roller.

In another embodiment, the mattress is not only cut along the length but also at least on one of the other sides.

In a particular form, the cut may is done by means of cutting and/or sawing.

In another form of the above method, whilst the mattress is moving forward between the rollers, the pins of both rollers are extended and when the rotation of the rollers is reversed the pins in at least one of the top and/or bottom rollers are retracted.

In yet another embodiment, the result of the cuts in the mattress takes the form of at least part of the shape of the letter U.

According to the present invention, there is also provided a device to automatically disassemble a mattress which has a mattress core between a top ticking and bottom ticking where this device includes a cutting mechanism to cut the mattress along the length on at least one side and the apparatus further includes spaced apart rotating top and bottom rollers between which a mattress with the cut facing forward is fed in to a rotating top and/or bottom roller with retractable pins fitted to the circumference of these rollers during which whilst the mattress is moving forward the extended pins remove the top and/or bottom ticking which then is wrapped around the top and/or bottom roller and whilst the pins are retracted in the rollers the bottom and/or top ticking is unwrapped from the rollers when their rotation is reversed.

In a particular embodiment of the above device, at least one of the rollers is mounted to the device at a fixed height. In another embodiment, the device has at least one adjustable in height roller, preferably the top roller, with which, together with a sensor and controllable actuator the distance between the bottom and top roller can be adjusted depending on the height or thickness of the mattress as measured by the sensor.

In a further embodiment, the device has fitted, near the top and/or bottom rollers, an adjustable row of pressure rollers to assist with the engagement of the top and/or bottom ticking with the pins. In one form, the pressure rollers may have an outer layer of elastic material. In a particular form, the pressure rollers have an outer layer of rubber.

In another embodiment of the above described device, the device has a programmable control system to run and control the multiple steps of the above described method. It will be appreciated that a person skilled in the art will have knowledge of an appropriate control systems or programmable microprocessors capable of suitable controlling the components of the disassembly apparatus discussed above.

As discussed in the foregoing, the cutting arrangement of the present invention is configured to apply at least one cut along a length (i.e. a lengthwise cut) of a perimeter surface of the mattress. The mattress ticking is at least partially connected to the mattress core via the perimeter surface textile and, in this regard, the cutting arrangement which applies the lengthwise cut (hereinafter referred to as a lengthwise cutter) partially separates the mattress ticking from the mattress core so as to facilitate removal of the ticking in the subsequent peeling stage.

As discussed above in relation to the optional corner cutter, it may be desirable to reduce the inherent tension or tautness in the outer layers of mattress quilting. As discussed above, the optional corner cuts are applied in a thickness direction of the mattress, perpendicular to the length direction and at least partially extending between the top and bottom ticking. Whereas the lengthwise cuts are suitable for reducing tension extending in the thickness direction between the top and bottom ticking, the corner cuts in the thickness direction are advantageous in that they remove or reduce tension extending in the lengthwise direction i.e. between the corners of the mattress. In embodiments of the invention where a mattress is conveyed through the recycling apparatus with the perimeter surface orientated vertically (i.e. the mattress resting on the bottom ticking such that the top ticking faces upwards) the thickness cuts will therefore be orientated vertically and the lengthwise cuts will be orientated horizontally.

According to another embodiment of the present invention, the apparatus further including a thickness cutter for applying a cut to one of the side or end surfaces, along the thickness direction. The thickness cutter may therefore apply a cut to the perimeter surface of the mattress in the same orientation as the corner cutter. However, in contrast to the corner cutter which applies a cut in the thickness direction to at least one of the four mattress corners, the thickness cutter applies a thickness cut to the end or side surfaces i.e. in between the mattress corners.

Advantageously, the thickness cutter may remove or reduce textile tautness or tension which extends between the corners of the mattress. Consequently, the tension between the textile and the edge of the mattress steel frame is also removed or reduced. Moreover, the thickness cutter, when applied to the same perimeter surface as the lengthwise cutter, can (in combination with the lengthwise cutter) create a grid or ‘criss-cross’ of cuts on the perimeter surface which provides improved severing of the ticking from the mattress core. As with the corner cutter, the cuts applied by the thickness cutter need not necessarily extend the whole distance between the top and bottom ticking and may extend only partially along the thickness direction. In this regard, a thickness cut which partially extends between the top and bottom ticking may sufficiently reduce the tautness of the perimeter surface and achieve the desired result. Alternatively, the thickness cutter may be configured to cut along the entire thickness of the end or side surface.

In some forms of the invention, the thickness cutter includes a plurality of cutting elements for applying a plurality of cuts along the thickness direction. To this extent, the thickness cutter may apply a greater number of thickness cuts to the perimeter surface, amplifying the desired tension-reducing effect in the perimeter surface. In embodiments of the invention which utilise a debris shield, each cutting element in the plurality of cutting elements may extend partially through a respective opening in the debris shield and thereby exposing a plurality of cutting portions. In some forms of the invention, the cutting elements may be formed from a rotating blade such as a cutting disc. In alternative embodiments, the cutting elements may be formed from a hot wire. In alternative forms of the invention, the thickness cutter may not include a solid cutting element and may, instead, include a fluid cutter or plasma cutter. It will be appreciated that other cutting devices may be appropriate for applying thickness cuts to the perimeter surface of a mattress and therefore a variety of alternative cutting devices may be appropriate for use with the thickness cutter.

The thickness cutter may include a debris shield to facilitate containment of mattress debris. Advantageously, the debris shield may help to contain mattress debris such as quilt or foam offcuts or textile dust in the cutting region of the thickness cutter and prevent, or reduce the amount of, debris which contacts the internal mechanisms of the thickness cutter. The debris shield may comprise a planar sheet member. In some forms of the invention, the cutting element includes a cutting portion extending partially through a respective opening in the debris shield. In this regard, the cutting portion which extends through the opening in the debris shield is configured to apply the thickness cut whilst the remainder of the cutting element, along with the associated mechanism is protected behind the debris shield. The debris shield may also, advantageously, function as a limiter to the depth of the thickness cuts. In this regard, the cutting portions extending from the openings in the debris guard can cut into the perimeter surface until abutment between the perimeter surface and the debris guard. To this extent, contact between the mattress and the debris guard allows for consistent thickness cut depth. Moreover, the debris guard presents an abutment to stop forward movement of the mattress in embodiments when the mattress is conveyed toward the thickness cutter.

It will be appreciated that the particular location, spacing or arrangement of the plurality of cutting elements may vary. However, in a particular embodiment, the plurality of cutting elements are arranged in a pair of spaced apart cutting groups for cutting a pair of spaced apart perimeter surface portions, each cutting group including a plurality of cutting elements. Advantageously, this form of the invention presents two spaced apart groups or clusters of cutting elements positioned to apply a plurality of cuts to two separate regions on the perimeter surface to which the thickness cuts are being applied. In some forms of the invention, the spacing between the cutting groups may be such that each cutting group applies a plurality of cuts to each end of the perimeter surface.

The cutting elements may be coaxially mounted to at least one axle. This form of the invention simplifies construction and ensures a constant alignment. In certain forms of the invention, each cutting group may be coaxially mounted to a respective axle. In this regard, the plurality of cutting elements in each cutting group may be coaxially mounted however each cutting group may be independently mounted, relative to one another. The cutting elements may be part of a saw such as a rotary saw, jig-saw or chain saw. In a particular form of the invention the cutting elements are cutting discs. In a particular form of the invention, each cutting group in the pair of cutting groups comprises a multi-blade rotary saw such as the cutting saws used in the lengthwise cutting arrangement. In contrast to the generally vertical axles of the saws used in the lengthwise cutting arrangement, the thickness cutter may include a pair of multi-blade saws orientated with a generally horizontal axis. In this regard, the cutting blades/cutting discs of the thickness cutter may be orientated generally vertically as distinct from the generally horizontal blades of the lengthwise cutter. In particular forms of the invention the cutting portions of the cutting discs are configured for downward movement, relative to the perimeter surface. This creates a downward force upon the mattress, pressing the mattress into the conveyor and reducing the likelihood of the mattress undergoing upward movement during elevation of the cutting elements. Of course, it will be appreciated that the rotational direction of the cutting elements could vary and, in alternative embodiments, could be reversed.

The thickness cutter may include an elevation-adjustment mechanism permitting upward and downward movement of the cutting elements relative to the perimeter surface to facilitate cutting of the perimeter surface in the thickness direction. This form of the invention advantageously allows for the application of longer thickness cuts. In this regard, the cutting elements are permitted to engage and cut a first portion of the mattress perimeter surface before being moved upwardly or downwardly, whilst maintaining cutting engagement, to extend the length of the thickness cut. Depending on the extent of elevation-adjustment and the size of the mattress, this form of the invention may allow for thickness cuts which extend the whole thickness of the mattress i.e. all the way between the top and bottom ticking. The direction of movement during cutting may vary. In a particular form of the invention, the cutting elements may commence cutting of a lower portion of the perimeter surface and then move upwardly in the direction of the top ticking. In alternative forms of the invention, the opposite sequence may occur.

In alternative forms of the invention, the thickness cutter may include no elevation adjustment and the length of the thickness cuts will be limited by the diameter of the cutting discs and/or the extent to which the cutting discs penetrate the perimeter surface.

According to a particular embodiment of the invention, the apparatus may further include a barrier member located above cutting element(s) and presenting a barrier against excess upward movement of the mattress during operation of the thickness cutter. This form of the invention is particular advantageous where elevation adjustment of the cutting elements is utilised and, in particular, where cutting commences at a lower part of the perimeter surface and where the cutting elements move in an upward direction toward the top ticking. Depending on the particular mattress, friction between the cutting elements and the mattress combined with the upward movement of the cutting elements may result in the mattress being lifted upward with the rising cutting elements. To this extent, the barrier member located above the cutting elements operates to prevent excess upward movement. Whilst a relatively small level of upward movement may be allowed to occur during upward movement of the cutting elements, the barrier member presents an upper limit to this movement. The barrier member may include a plurality of downward-extending projections. In instances where the mattress is lifted upward by the elevating cutting elements, the projections on the barrier member advantageously provide an engagement between the mattress and barrier member and partially secures the mattress against the barrier member, thereby retaining the mattress in position during operation of the thickness cutter.

The apparatus may further include an actuating arrangement for adjusting the vertical position of the barrier member. Advantageously, this allows for the position of the barrier member to change depending on the thickness of the mattress. In this regard, the actuating arrangement may be configured to maintain a constant spacing between the barrier member and the top ticking of a mattress and to adjust the position of the barrier member according to the thickness of the particular mattress.

In a particular form of the invention, the thickness cutter is movable between a retracted position and a cutting position, the apparatus further including a plurality of conveying rollers located above the thickness cutter to facilitate conveyance of the mattress when the thickness cutter is in the retracted position. As discussed in the foregoing, the present invention may include a conveyor for transporting the mattress through the (lengthwise) cutting arrangement and toward the peeling rollers. The thickness cutter may advantageously be retractable to a position beneath the level of the conveyor such that the plurality of conveying rollers is aligned with the level of the conveyor. In this regard, the mattress may undergo thickness cuts when the thickness cutter is in the cutting position and subsequently be conveyed by along the plurality of conveying rollers when the thickness cutter is in the retracted position. Advantageously, this arrangement allows for the thickness cuts to be applied and for the recycling process to continue in a streamlined and efficient manner. In particular embodiments, the thickness cutter may be located between the lengthwise cutter and the peeling roller(s). In such an arrangement, the perimeter surface would first undergo lengthwise cutting, followed by thickness cutting and would subsequently be fed toward the peeling roller(s) for removal of mattress ticking.

The plurality of conveying rollers may be driven to rotate by a driving arrangement. Advantageously the plurality of conveying rollers may thereby actively convey the mattress. Alternatively, the plurality of conveying rollers may be passive i.e. rotatably mounted but not otherwise driven. In this form of the invention, the mattress may be driven by the conveyor across the plurality of conveying rollers until in close enough proximity to the peeling roller(s) that the mattress is engaged by the pins of the peeling roller. The plurality of conveying rollers may include a plurality of gripping projections extending outwardly from the circumference of the conveying rollers. This form of the invention may be particularly advantageous where the plurality of conveying rollers are driven to rotate by a driving arrangement insofar as the plurality of gripping projections will assist to grip and convey the mattress across the plurality of conveying rollers toward the peeling roller(s). In alternative forms of the invention, the apparatus may include a belt conveyor in lieu of conveying rollers. It will be appreciated that a variety of alternative conveying devices may be appropriate for conveying the mattress between the thickness cutter and the peeling station and that these alternatives are envisaged within the scope of the present invention.

A discussed in the foregoing, the apparatus may include a sensor for determining the position and/or dimensions of a mattress and for adjusting the spacing of the peeling rollers accordingly. In embodiments of the invention where a thickness cutter is employed, the data from the sensor may, in some embodiments of the invention, be used to trigger the thickness cutter or to control movement of the elevation-adjustment mechanism or to control the vertical position of the barrier member or all of the foregoing.

In an example application of an apparatus according to a particular embodiment of the present invention, the sensor may be positioned between the lengthwise cutter and the thickness cutter, located overhead and directed toward the conveyor below. When the sensor detects the edge of an oncoming mattress, an electronic controller to which the sensor is connected can trigger activation of the thickness cutter, this timing being proportionate to the speed of the conveyor. At the predetermined time, the controller may trigger the elevation-adjustment mechanism of the thickness cutter causing the thickness cutter to elevate from its retracted position to its cutting position. At this time, the controller may also trigger activation of the saws in the thickness cutter and adjust the vertical position of the barrier member based on the determined height of the mattress, as identified by the sensor. Based on the information provided by the sensor, the controller may, terminate movement of the conveyor once it is determined that the mattress has reached the thickness cutter. The cutting elements of the thickness cutter may commence cutting in a lower cutting position and, after a predetermined, the controller may then active the elevation-adjustment mechanism causing the cutting elements to elevate with respect to the mattress and thereby extend the thickness cuts upwardly toward the top ticking. Once cutting is complete, the thickness cutter may move downwardly, returning to its retracted position, and aligning the plurality of conveying rollers above the thickness cutter with the conveyor. The controller may then re-activate the conveyor along with the driving arrangement to drive rotation of the plurality of conveying rollers and thereby convey the mattress toward the peeling roller(s).

The above example application of a thickness cutter according to the present invention combines each of the optional features associated therewith however it is to be appreciated that the thickness cutter may, alternatively, operate with only some, but not all, of the above-discussed features.

As discussed in the foregoing, the present invention may also related to a method of disassembling a mattress. Further to the above-discussed thickness cutter, the method of disassembling a mattress may be augmented with the addition of thickness cuts applied by the thickness cutter. In this regard, the method of disassembling a mattress may include the step of applying at least one thickness cut along a thickness of the perimeter surface, perpendicular to the lengthwise cut, and extending at least partially between the bottom and top ticking. The step of applying a thickness cut may be performed after the at least one cut along a length of the perimeter surface and before the feeding of the mattress into the at least one peeling roller.

As foreshadowed in the above discussion of a sensor in the apparatus, the method of disassembling a mattress may also include the steps of; applying at least one thickness cut along a thickness of the perimeter surface, perpendicular to the at least one cut along a length of the perimeter surface, and extending at least partially between the bottom and top ticking, the thickness cut being applied by a thickness cutter; and adjusting the position of the thickness cutter based on the determined position and/or dimensions of the mattress.

In some forms of the invention, the plurality of thickness cuts is applied such that each thickness spaced apart along a lengthwise direction of the mattress. In some embodiments of this method, the thickness cuts may be applied in an upward direction, toward the top ticking.

As discussed in the foregoing, the removal of ticking from the peeling surface of the peeling roller may generally involve reversing the rotation of the peeling roller such that the ticking is ‘unwound’ from the peeling surface. As is also discussed in the foregoing, some embodiments of the invention may utilise a particular pin movement sequence to engage mattress a peeling roller with ticking until peeling has occurred and to retract pins once peeling has occurred so as to disengage with the mattress ticking to allow for the peeled ticking to be directed away from the peeling roller.

According to a particular aspect of the invention, there is provided a method of disassembling a mattress, the mattress including a mattress core between a top ticking and a bottom ticking and the mattress having a perimeter comprising a pair of opposing side surfaces extending in a longitudinal direction and a pair of opposing end surfaces extending between the opposing side surfaces, the method including: applying at least one cut along a length of at least one of the perimeter surfaces; feeding the mattress, in a cut-first orientation, between a pair of top and bottom rotating peeling rollers, the peeling rollers each having a peeling surface with retractable pins movable between a retracted position and an extended position; moving the pins of the top roller to their extended position to engage and remove the top ticking of the mattress, the top ticking being subsequently wound about the top roller; executing a pin movement sequence in the pins of the bottom roller wherein a row of pins of the bottom roller move to their extended position prior to contact with the bottom ticking, to engage and remove a portion of the bottom ticking and wherein the row of pins subsequently return to their retracted position after contact and peeling of the ticking portion to permit disengagement between the bottom roller and the ticking portion and facilitate the deposit of the bottom ticking beneath the bottom roller; and moving the pins of the top peeling roller to their retracted position and reversing the direction of the top roller to disengage and unwind the top ticking from the top roller.

In the above method, the top ticking is engaged by the pins of the top roller, peeled away from the mattress core and wound about the top peeling roller. Meanwhile, the bottom ticking is engaged with the bottom roller only until peeling has occurred, at which point the pins of the bottom roller retract once having rotated a sufficient distance away from the mattress core. As discussed above, some embodiments of the invention may include a row of guiding rollers positioned adjacent to or in abutment with the bottom peeling roller. The pin movement sequence of the bottom peeling roller may therefore include the step of retracting the pins once they pass below the guide roller. This allows the peeled ticking to disengage from the bottom peeling roller and be subsequently deposited beneath peeling rollers. According to this method, once peeling of the mattress is complete, the bottom ticking will therefore have already been deposited beneath the bottom peeling roller whilst the top ticking will still be engaged by the pins of the top peeling roller and will be typically wound around the top peeling roller. In the next stage of the method, the pins of the top roller are retracted and rotation of the top roller is revered to ‘unwind’ the ticking therefrom.

In a particular form of this method, the rotation and pin movement sequence of the bottom roller is maintained during disengagement of the top ticking to facilitate engagement between the top ticking and the bottom roller and to deposit the top ticking beneath the bottom roller. Advantageously, the unwound top ticking can fall under the influence of gravity from the top roller and be engaged by the extended pins of the bottom roller. As was the case with the bottom ticking, once the top ticking is engaged by the bottom roller the top ticking may be directed downward by rotation of the bottom roller and between the guide roller whereupon the pins of the bottom roller are retracted and the top ticking thereby deposited beneath the bottom roller.

It will therefore be appreciated that the top roller undergoes a reversal of direction after the peeling of the top ticking whereas the bottom roller is rotated in a single direction throughout the whole process and does not undergo a reversal of direction. Advantageously, this method of disassembling a mattress utilises the independent pin movement of the bottom roller to peel mattress ticking from the mattress core and to remove the peeled ticking from the peeling rollers in a timely manner so as to improve the overall efficiency of the recycling apparatus and process.

With reference to the above discussion it will be appreciated that an embodiment of the method according to present invention can include the steps of moving a longitudinal row of pins on the bottom peeling to engage with a portion of the bottom ticking; rotating the bottom roller in a peeling direction to peel the portion of bottom ticking from the mattress core; moving the longitudinal row of pins to their retracted position to disengage with the portion of the bottom ticking.

The present invention will now be further described by the following non-limiting examples. It is to be understood that the following description is for the purpose of describing particular embodiments only and is not intended to be limiting with respect to the above description.

### BRIEF DESCRIPTION OF DRAWINGS

FIG. 1 is a perspective view of a mattress peeler forming part of a mattress disassembly apparatus according to the present invention.

FIG. 2 is a diagram illustrating the various components of a mattress and the interaction with a cutting device as part of the method and apparatus according to the present invention

FIG. 3 is a close-up perspective view of a retractable pin arrangement in a peeling roller according to the present invention.

FIG. 4 is a perspective view of a mattress disassembly apparatus according to the present invention.

FIG. 5 is an illustration of a mattress recycling process incorporating a mattress disassembly apparatus and method according to the present invention

FIG. 6 is an illustration of a peeling roller having curved pins which provides an alternative to the embodiment illustrated in FIG. 3.

FIG. 7 is a view of a multi-blade saw in an alternative embodiment of the present invention.

FIG. 8 is a perspective of an embodiment of the invention where the cutting arrangement includes a pair of the multi-blade saws illustrated in FIG. 7.

FIG. 9 is a cross sectional view of a peeling roller according to an embodiment of the present invention with pins in an extended position.

FIG. 10 is a cross sectional close up view of a pin actuator mechanism with a pin in an extended position

FIG. 11 is a cross sectional close up view of the pin actuator mechanism of FIG. 10 with a pin in a retracted position

FIG. 12 is a diagram of a peeling process performed by an embodiment of the present invention.

FIG. 13 is a side perspective of a manual adjustment mechanism for adjusting the position of the bottom roller in an embodiment of the present invention.

FIG. 14 is a perspective of the cutting arrangement illustrated in FIG. 8 with an additional corner cutting device.

FIG. 15 is a perspective view of an alternative embodiment of the present invention including a pair of top rollers applied to the top surface of the mattress.

FIG. 16 is a side view of a mattress disassembly apparatus according to an alternative embodiment of the invention in which a top conveyor is included at the cutting station.

FIG. 17 is a perspective view of the peeling rollers according to an embodiment of the invention.

FIGS. 18 to 21 illustrate an operation sequence of the peeling rollers illustrated in FIG. 17.

FIGS. 22 to 27 illustrate a thickness cutter apparatus for applying thickness cuts to the mattress and an operation sequence for applying the thickness cutter.

### DETAILED DESCRIPTION

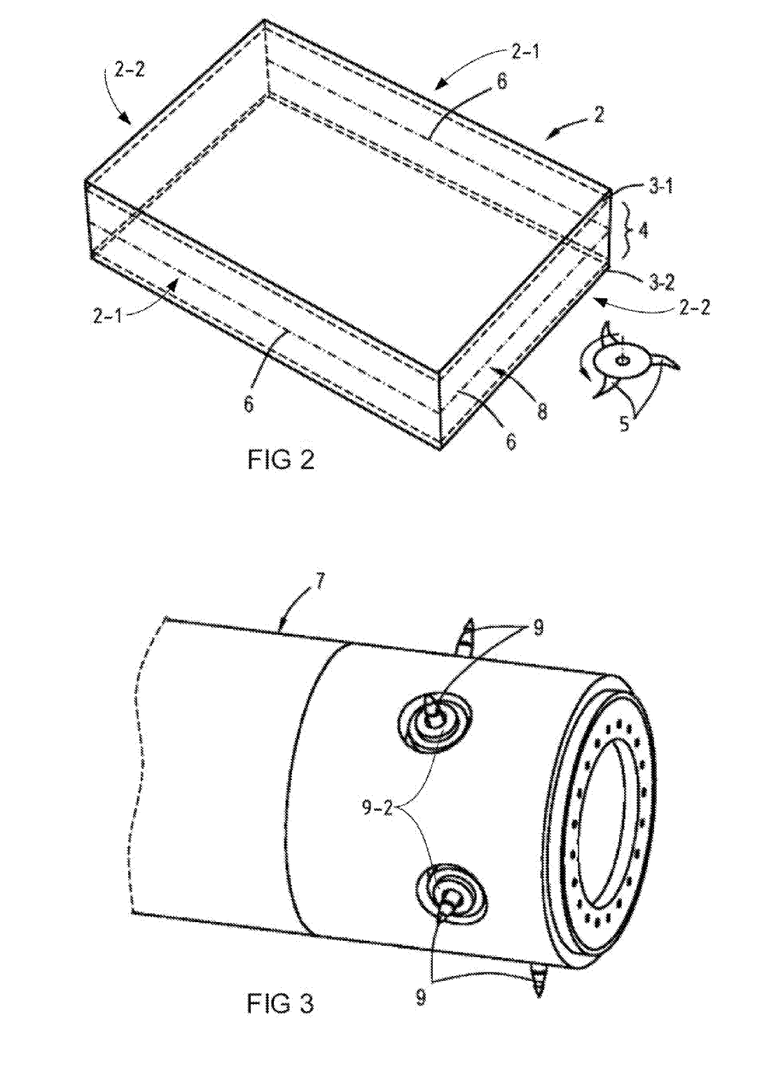

As briefly discussed in the background to the invention, mattresses to which the present invention are applicable may come in a variety of shapes and sizes and contain a variety of internal materials in a various quantities. The illustrated embodiment relates to a typical rectangular sleeping mattress 2, shown in FIG. 2, having a mattress core 4 between a top ticking 3-1 and a bottom ticking 3-2. The perimeter of mattress 2 comprises a pair of opposing side surfaces 2-1 extending in a longitudinal direction and a pair of opposing end surfaces 2-2 extending between the opposing side surfaces 2-1.

Between the mattress core 4 and the top and bottom layers of ticking 3-1, 3-2 is several layers of cushioning foam and felt which are sought to be removed throughout the recycling process. The reasons for removal of these layers is firstly to recover and sort recyclable material from these internal layers and secondly to free the metal spring core from as much associated upholstery as possible in order for the spring core to be more readily recyclable in a metal shredding device of a downstream recycling process. As discussed above, some mattresses will contain a mattress core 4 formed by metallic springs or coils while other mattresses will contain a mattress core formed by foam or other non-metallic materials. In either case, the out layers of ticking 3-1, 3-2 must first be removed before subsequent recycling processes can take place.

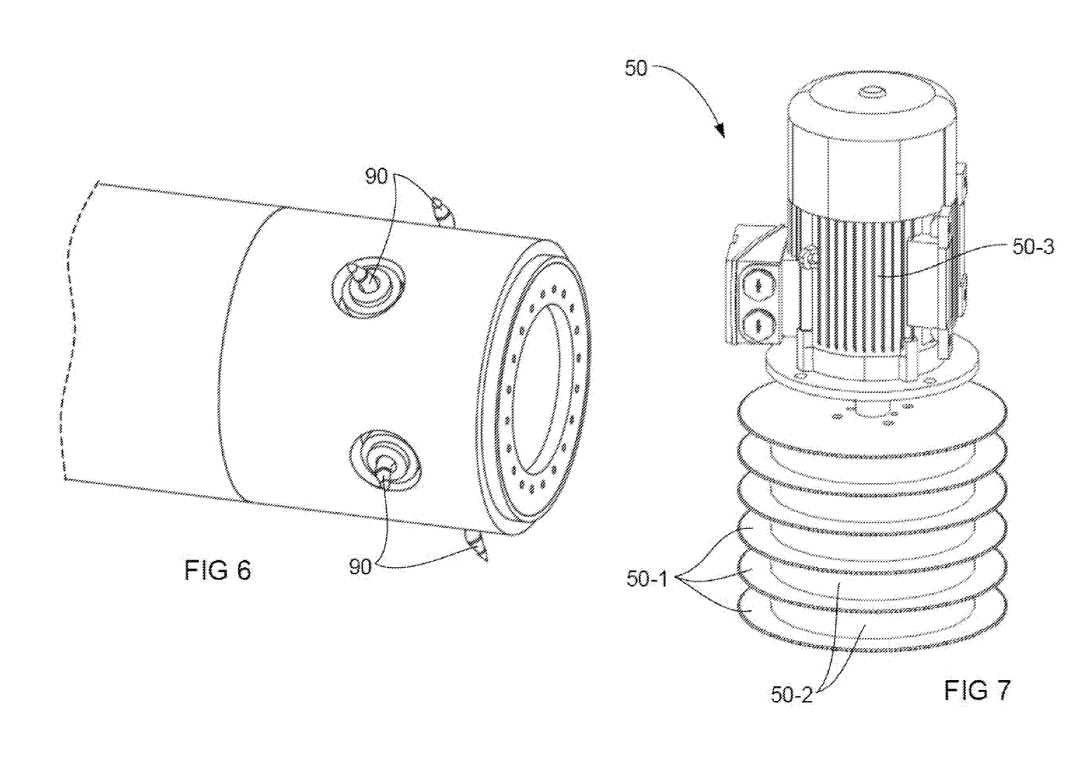

By way of contextual background, a mattress recycling process 14 is illustrated in FIG. 5 incorporating an embodiment of the apparatus and method of mattress disassembly which will be discussed in further detail below. At the first stage of the illustrated process, a supply of mattresses 2 is transferred to a supply bunker 14-1 which is fed via a conveyor to a metering conveyor 14-2. In the illustrated example, the metering conveyor 14-2 is sloped steeply such that mattresses 2 are not capable of being conveyed up the slope by conveyor friction alone. To assist in conveying mattresses 2, a hook element is embedded into metering conveyor 14-2 which periodically grasps a unitary mattress 2 and conveys the mattress 2 up the slope of the metering conveyor 14-2. In this way, the feed of mattresses from the plurality of mattresses 2 at supply bunker 14-1 is metered and each mattress 2 is consistently spaced apart on the conveyor line.

At the next stage of the mattress recycling process 14 illustrated in FIG. 5, a metal detector station 14-3 identifies and separates mattress 2 having metal components and those without. Mattresses 2 are subsequently conveyed to one of two separate conveyor lines, one for mattresses containing metal and one for mattresses without metal. Irrespective of metal content, mattresses 2 are then conveyed to a cutting station 14-4. The specifics of the cutting station will be discussed in more detail below. However by way of general summary, cutting station 14-4 applies a U-shaped cut to three sides of the mattress. The purpose of this cut is to facilitate the subsequent processing stage at which the mattresses 2 enter a peeling station 14-5 which peels away the top and bottom ticking 3-1, 3-2 from the mattress core 4. After the peeling station 14-5, peeled layers of cotton are directed toward the cotton baler 14-6 and metallic mattress cores are directed to a metal shredder 14-7. Remaining materials are subsequently separated between polyurethane foam and latex foam before being sliced into smaller portions at roll cutters 14-10. The polyurethane foam slices are then directed to PU foam baler 14-8 and latex foam slices are directed to latex foam baler 14-9. Baled materials may then be conveniently stockpiled according to type ready for collection and transport.

In the context of the above described mattress recycling process, the mattress disassembly apparatus and method of the present invention will be better understood as specific embodiments of the invention are now discussed in greater detail.

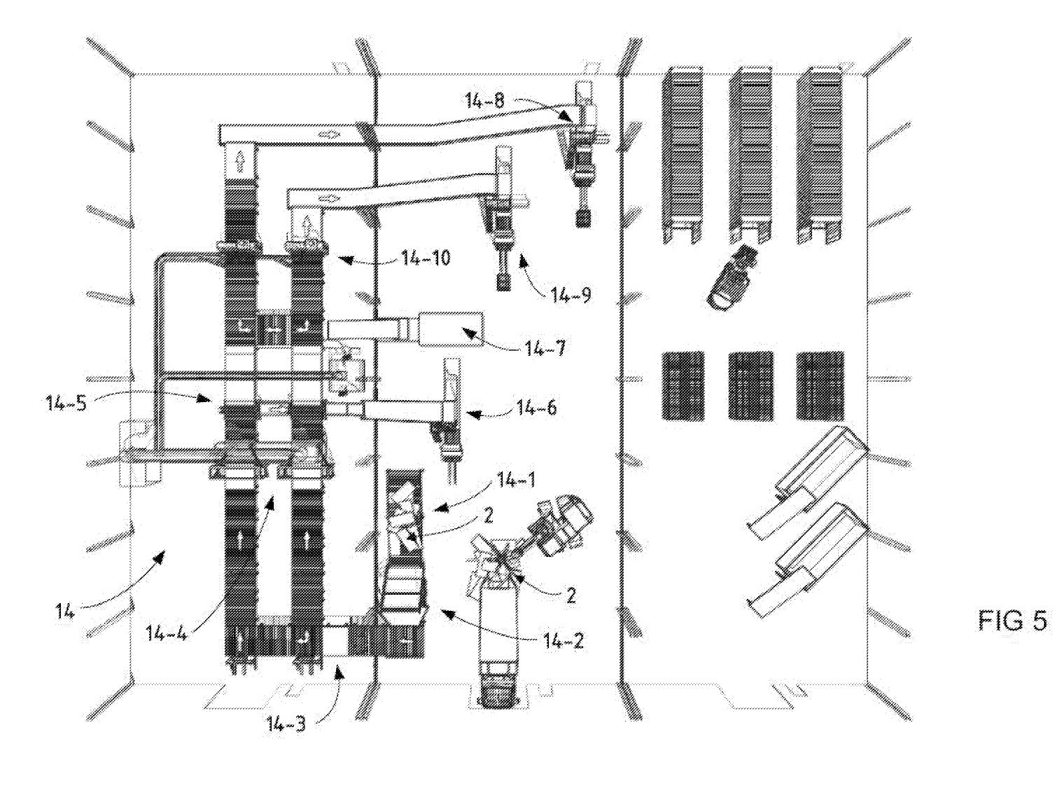

Referring firstly to FIG. 4, there is illustrated a mattress disassembly apparatus 1 according to an embodiment of the present invention. Apparatus 1 includes a cutting station 14-4 and a peeling station 14-5. Cutting station 14-4 is downstream of from cutting station feed conveyor 13-1 and therefore positioned to receive a feed of mattresses 2 therefrom. The direction of the feed of mattresses 2 is indicated by arrow “A”. At the end of feed conveyor 13-1 is a cutting station conveyor 13-2 which conveys a mattress 2 through a cutting process. Each of the conveyor surfaces may include a non-slip surface.

In this regard, cutting station 14-4 includes a pair of pivotally mounted cutting arms 5-4 with a respective saw 5 mounted to the free ends of each cutting arm 5-4. The cutting arms 5-4 are biased to a normal position at which the free ends of the cutting arms 5-4, and the pair of saws 5 mounted thereto, are suspended above and are generally centrally of cutting station conveyor 13-2. In the normal position, one saw 5 is positioned upstream of the other saw 5. The spacing between the saws 5 is sufficient such that the radii defined by the free ends of each of pivotally mounted cutting arms 5-4 do not intersect and, therefore, the upstream and downstream saws 5 cannot come into contact with one another. The saws 5 each include a rotatable saw blade 5-1 powered by saw motor 5-3.

During operation of the cutting station 14-4, a mattress 2 is conveyed by cutting station conveyor 13-2 into contact with the saw blade 5-1 of the upstream saw 5. Turning briefly to FIG. 2, it will be appreciated that the mattress perimeter surface 8 which faces downstream will be the first surface to contact the saw blades 5-1. As illustrated in FIG. 2, the mattress may be orientated with one of the opposing end surfaces 2-2 as the downstream surface. Alternatively, the downstream perimeter surface 8 could be one of the opposing side surfaces 2-1, depending on the orientation of the mattress 2 on conveyors 13-2.

Referring again to FIG. 4, downstream perimeter surface 8 will contact the saw blade 5-1 of the upstream saw 5, which rotating due to motor 5-3. Under the influence of cutting station conveyor 13-2, the movement of mattress 2 overcomes the bias in cutting arms 5-4 which are subsequently driven to swing about their pivotal mounting. Saws 5 are thusly swung away from their central position above conveyor 13-2 while being maintained in contact with a perimeter of the mattress 2 due to the bias in the cutting arms 5-4. In this manner, the upstream saw 5 contacts mattress 2 in a generally central position of downstream perimeter surface 8 and travels outwardly, away from the centre of conveyor 13-2, toward the corner of the mattress before tracing around the corner and following along the perimeter surface of the mattress parallel with the direction of conveyance A. The downstream saw 5 behaves in a similar fashion but travels around the perimeter of mattress 2 in the opposite direction to the upstream saw 5.

Referring to FIG. 2, it will thusly be appreciated that saws 5 will cooperate to produce a U-shaped cut 6 on three sides of the mattress perimeter surface. In this regard, each saw 5 may perform an L-shaped cut therefore both saws 5 combining to perform a U-shaped cut 6. When saws 5 reach the end of the side surfaces 2-1, the mattress 2 has therefore exited the radii of the cutting arms 5-4 which, under the influence of their bias, are subsequently returned to their normal position, ready for the next mattress 2 to enter the cutting station. Accordingly, in the illustrated embodiment, the upstream perimeter surface of mattress 2, opposite to downstream surface 8, may not necessarily be cut by the cutting station 14-4. Of course, it is possible for some incidental cutting to occur on the upstream surface in the region of the upstream corners of the mattress as the cutting arms 5-4 pivotally return to their normal position.

In the preferred embodiment, the direction of saw blade 5-1 rotation is specific to each saw 5 in order to assist in the pivotal movement of the cutting arm 5-4. In other words, each saw blade 5-1 will rotate in a direction so as to ‘roll around’ the perimeter surface of the mattress. In the illustrated embodiment, the upstream saw blade 5 is mounted so as to swing around the right hand side of mattress 2 (relative to the conveyance direction A) rotate in a clockwise direction (when viewed from above saw 5). Accordingly, the downstream saw 5, which is mounted to swing around the left hand side of the mattress 2, will rotate in an anti-clockwise manner. In this regard, it will be appreciated that the portion of saw blade 5-1 contacting the mattress 2 is moving in the direction of the mattress 2 relative to the cutting arm 5-4, thereby facilitating the swinging movement of the cutting arm 5-4 around the three perimeter surfaces of mattress 2.

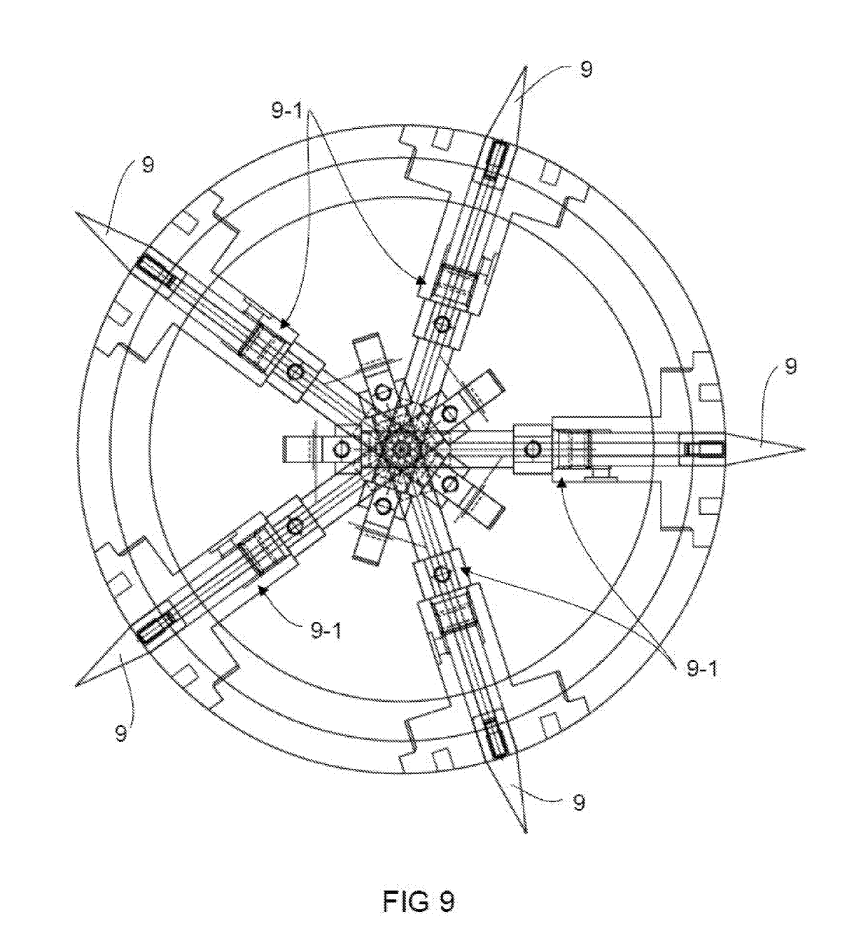

As illustrated in FIG. 4, saws 5 may include a single cutting blade 5-1. In a preferred alternative embodiment illustrated in FIG. 7, multi-blade saw 50 includes a plurality of blades 50-1. In the embodiment, each of blades 50-1 comprise a toothed disc including cutting teeth however it will be appreciated that other cutting elements may be utilised for example a toothless slicing disc or even a saw having a combination of toothed and toothless cutting elements. In the particular embodiment illustrated in FIG. 7, six toothed saw blades 50-1 are arranged coaxially in a stacked configuration and spaced apart by spacers 50-2. The six blades 50-1 and five spacers 50-2 thereby share a common axle driven by an overhead motor 50-3.

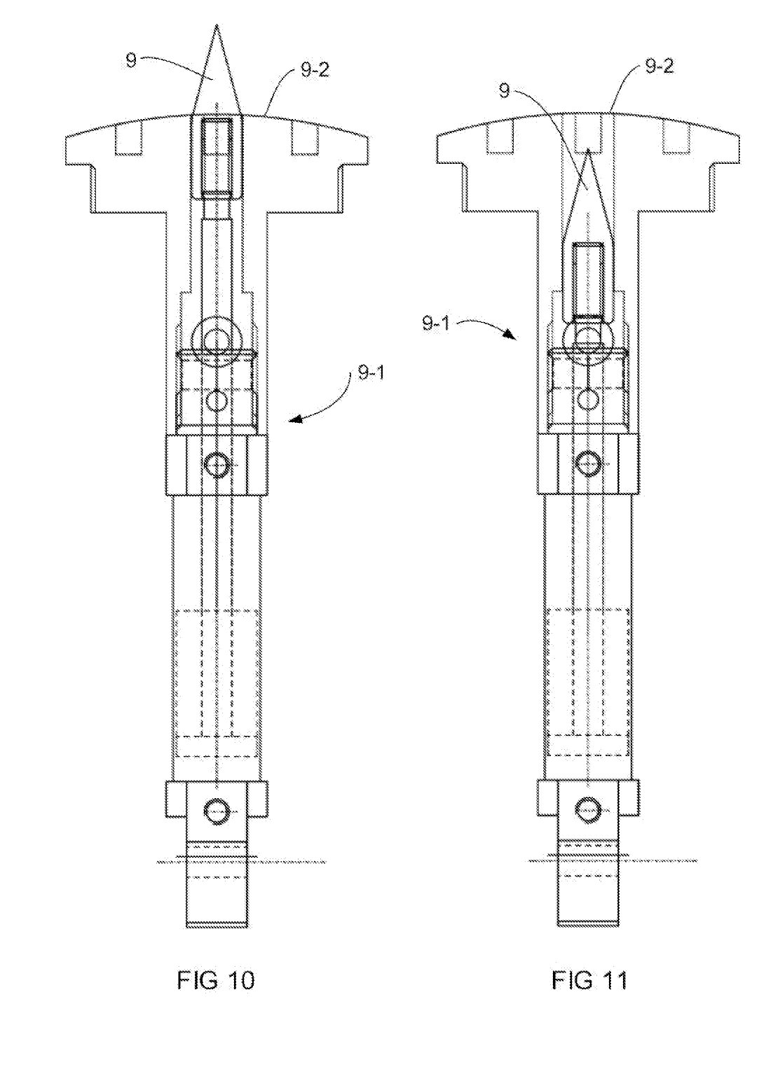

Turning now to FIG. 8, there is illustrated a pair of multi-blade saws 50, each mounted to the free end of a respective cutting arm 5-4. As illustrated, multi-blade saw 50 applies a plurality of parallel cuts 60 to the mattress perimeter, each of the cuts in the plurality of cuts corresponding with one of the saw blades 50-1 on the multi-blade saw 50. As discussed above, it will be appreciated that applying a plurality of cuts 60 increases the degree to which the top and bottom ticking 3-1, 3-2 is partially freed from the mattress core 4. This embodiment is particularly advantageous when processing mattresses that have hog rings or other internal stapling elements that provide an additional source of connection between the ticking 3-1, 3-2 and the mattress core 4. In this regard, the applying a plurality of cuts 60 significantly increases the likelihood of severing the connection between the outer layers of the mattress 2 and the internal connective elements.

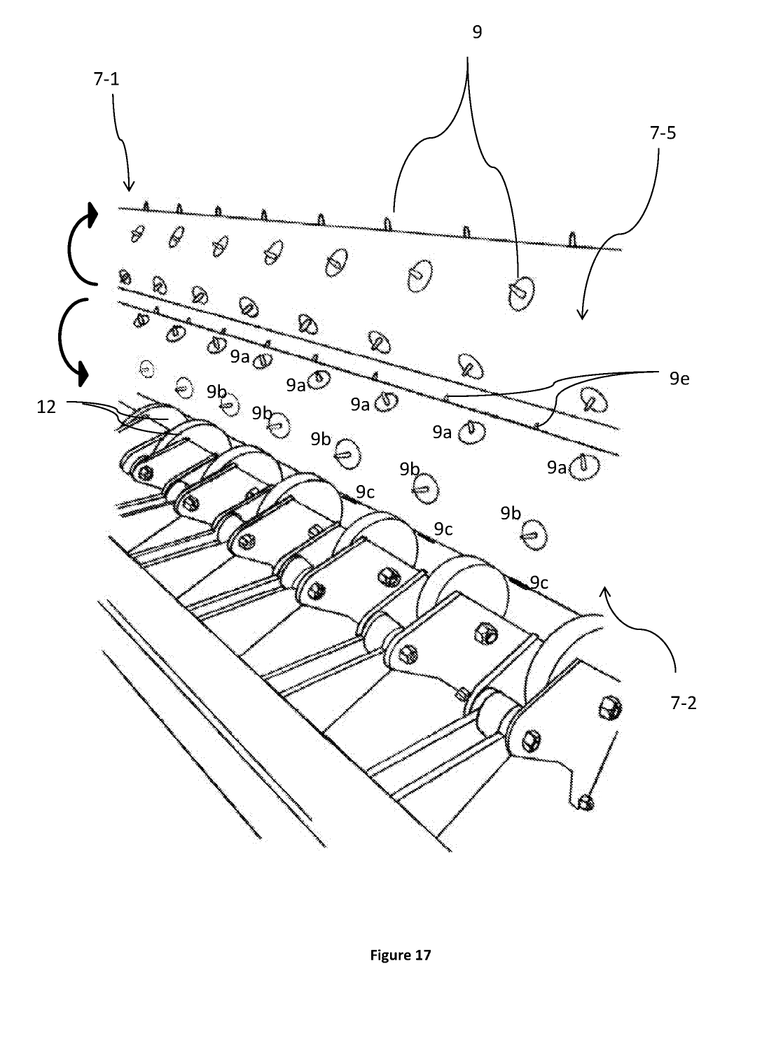

Turning now to FIG. 14, in an alternative embodiment of cutting station 14-4, there may be provided means for cutting the perimeter corners of mattress 2 to further facilitate the release of the outer quilting layers from the mattress core 4 and also to release the tension throughout the outer quilting/ticking. To this end, a corner cutting device 5-5 comprises a corner cutting arm 5-6 with a corner cutting saw 5-7 mounted at the free end thereof. The corner cutting blades 5-8 are arranged in a generally vertical orientation so as to apply a generally vertical cut 5-9 to a corner of mattress 2, where one of the perimeter side surfaces 2-1 meets one of the perimeter end surfaces 2-2. The generally vertical cut 5-9 may extend all the way or, alternatively, a partial distance between, the top ticking 3-1 and the bottom ticking 3-2. In some embodiments, the corner cut 5-9 may be applied prior to the application of cut 6 by saws 5. In other embodiments, the corner cut 5-9 may be applied after mattress 2 has undergone cutting by saws 5.

Still referring to FIG. 4, after exiting the cutting station 14-4, cutting station conveyor 13-2 conveys mattress 2 to a peeling station feed conveyor 13-3 which subsequently feeds mattress 2 into peeling station 14-5. As discussed above, the purpose of peeling station 14-5 is to peel away the top and bottom ticking 3-1, 3-2 from the mattress core 4. In this regard, the cut 6 applied by cutting station 14-4 to some of the perimeter surfaces of mattress 2 will greatly facilitate the peeling process conducted at peeling station 14-5.

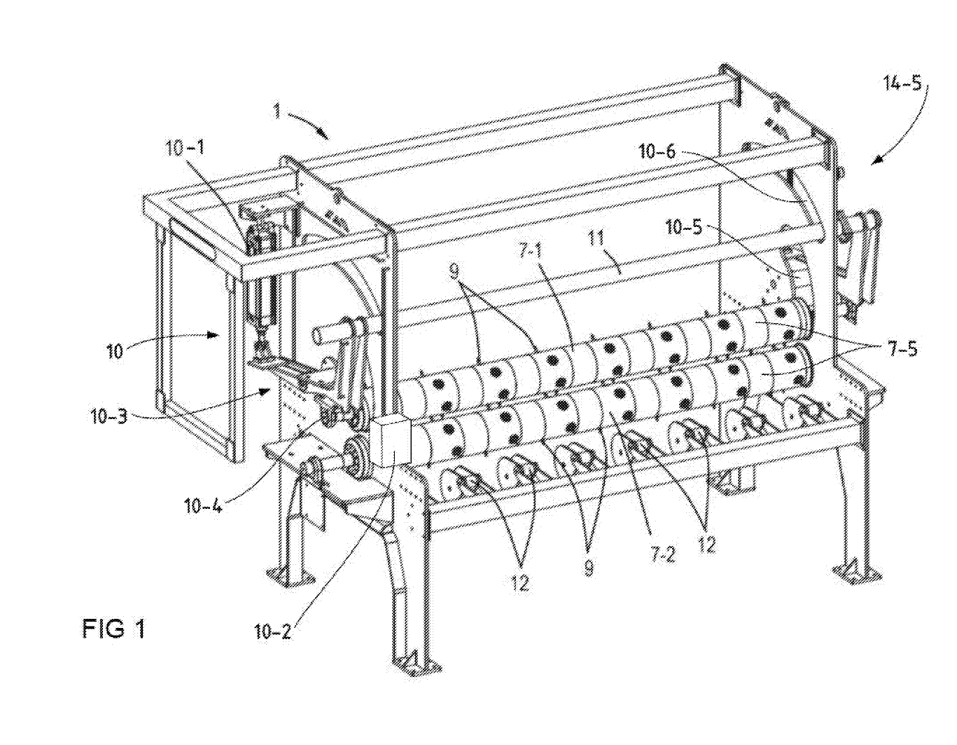

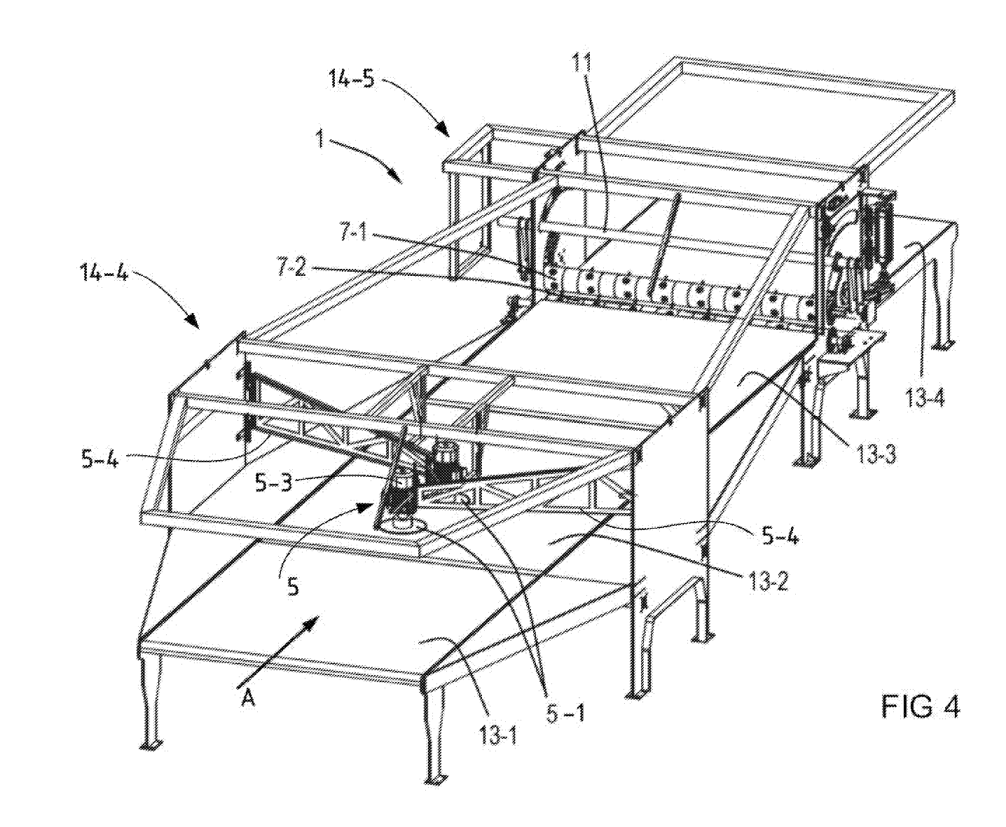

Turning now to FIG. 1 there is illustrated a specific perspective of the apparatus of cutting station 14-5. FIG. 1 illustrates a pair of peeling rollers 7 comprising a top peeling roller 7-1 and bottom peeling roller 7-2, the pair of peeling rollers 7 each having a peeling surface 7-5 and being spaced apart to receive mattress 2 therebetween. On the circumferential peeling surface 7-5 of each peeling roller 7 is a series of retractable pins 9, better illustrated in FIG. 3. The size of rollers 7 are at least as long as a mattress side surface 2-1 so as to be suitable to receive a mattress 2 with its widest side orientated downstream as the mattress 2 enters peeling station 14-5. In an embodiment of the invention, the peeling rollers 7 are driven by electric motors thereby allowing the speed of roller rotation to be conveniently adjusted as necessary.

During operation of the peeling station 14-5, a mattress 2 is conveyed along peeling station feed conveyor 13-3 into peeling rollers 7 which, at this stage, have pins 9 in an extended or partially extended position. As will be appreciated with reference to the discussion above, the downstream perimeter surface 8 of mattress 2 now includes a cut 6 (or cuts 60 in the case of multi-blade cutter 50) from cutting station 14-4 which, as illustrated in FIG. 2, also extends around perimeter side surfaces 2-1. As mattress 2 is fed into the peeling station 14-5, the rotation of peeling rollers 7 cooperate to receive mattress 2 such that the lower circumference of the top roller 7-1 and the upper circumference of the bottom roller 7-2 are each moving in the conveyance direction. As the downstream mattress perimeter surface 8 contacts peeling rollers 7, the extended pins 9 of the top 7-1 and bottom 7-2 peeling rollers penetratingly engage with the top 3-1 and bottom 3-2 layers of mattress ticking. As downstream perimeter surface 8 passes through peeling rollers 7 the pins 9 engaged with the ticking 3-1, 3-2 begin to rotate away from the mattress core 4. Facilitated by cut 6, the each of the downstream edges of ticking 3-1, 3-2 is thereby peeled away from the mattress core 4 by the outward movement of pins 9, relative to the mattress core 4. By this operation, top ticking 3-1 is subsequently pulled in a backward, upstream, direction over the top of top peeling roller 7-1 while bottom ticking 3-2 is pulled in a backward, upstream direction below bottom peeling roller 7-2. During this peeling state, the rotation of rollers 7 can therefore be said to be rotating in a peeling direction.

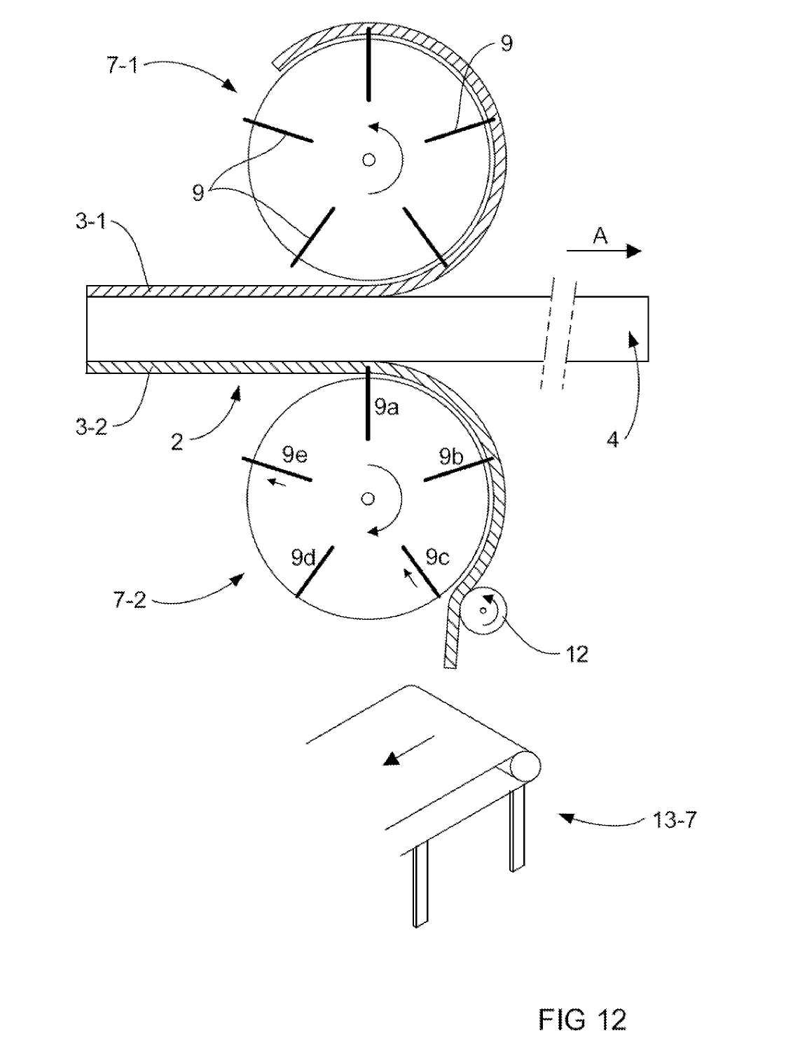

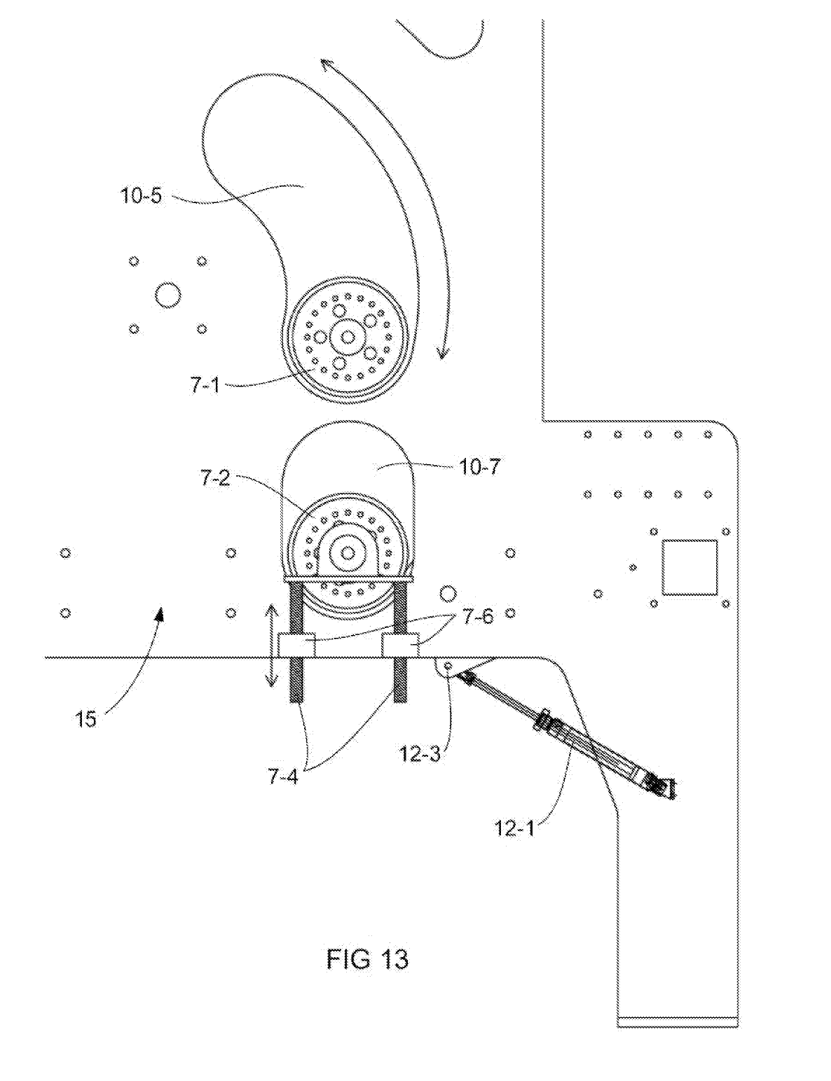

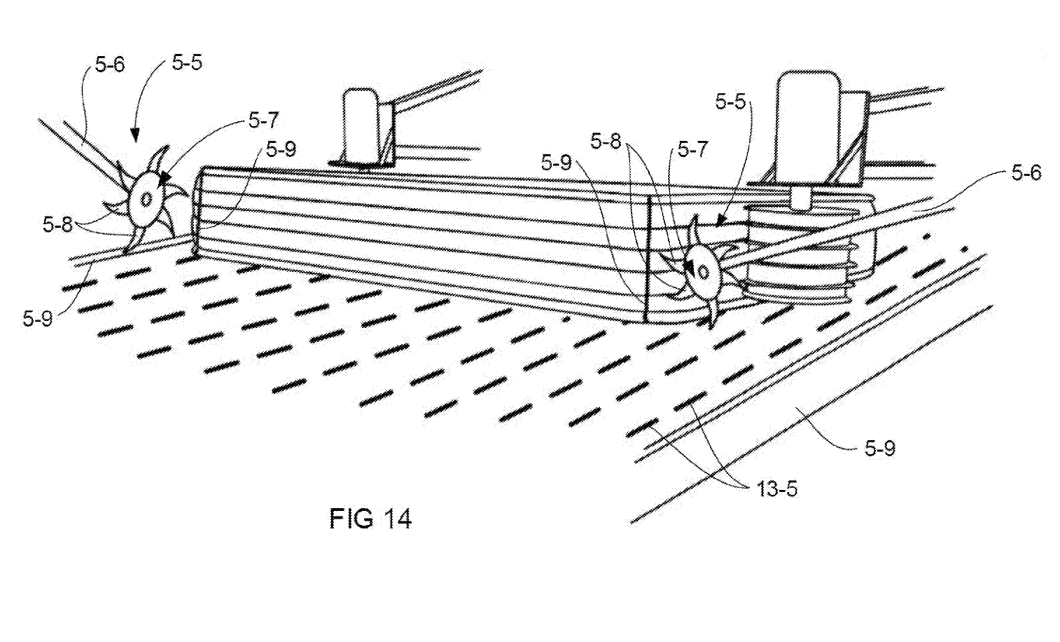

Turning now to FIGS. 9 to 11, the operation of the pins 9 will be described in greater detail. With reference to FIG. 9, the movement of each of pins 9 is controlled by individual electro pneumatic actuators 9-1 each associated with a respective pin 9. Of course, it will be appreciated that other forms of the invention, the pin actuators may be associated with a number of pins 9 for example one actuator per ‘row’ of pins extending in a longitudinal direction along the peeling roller 7. As illustrated in FIG. 9 and also FIG. 3, each pin 9 may be extended or retracted by the respective pin actuator 9-1 through an opening 9-2 in the peeling roller 7. A closer view is provided in FIGS. 10 and 11 in which the pin 9 is illustrated as extended and retracted respectively.

The precise behaviour of the peeled ticking 3-1, 3-2 may vary between mattresses 2 however in many cases the ticking will become wrapped around at least one of the peeling rollers 7. For this reason, after mattress core 4 exits peeling station 14-5, the peeling rollers 7 undergo a ticking disengagement stage to remove the ticking from peeling rollers 7. In the ticking disengagement stage, pins 9 are moved to a retracted position in peeling rollers 7 and the direction of peeling roller 7 rotation is reversed to as to ‘unwrap’ the ticking 3-1, 3-2 from the peeling surface 7-5 of at least one of the peeling rollers 7. The removed ticking 3-1, 3-2 which will often be a durable cotton-based textile is subsequently conveyed away from peeling station 14-5 to an appropriate baling stage. This will best be understood with brief reference to FIG. 5 which illustrates peeling station 14-5 adjacent to cotton baler 14-6 and connected by a conveyor mechanism therebetween. During the above described disengagement or removal stage, the rotation of peeling rollers 7 operates to remove the ticking and the peeling rollers can therefore be said to be rotating in a ‘removal direction’.

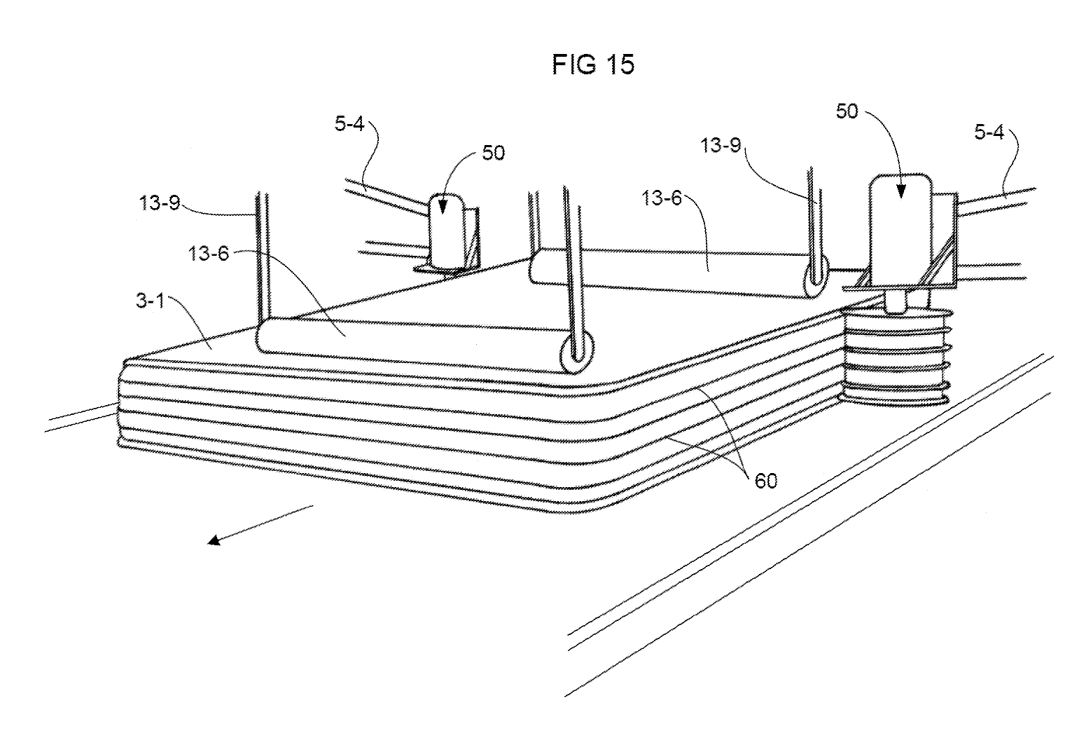

Referring again to FIG. 1, the peeling station 14-5 in the illustrated embodiment includes several additional components to assist in the peeling process. Adjacent to a side of bottom peeling roller 7-2 is a row of guiding rollers 12 positioned to guide the peeled bottom ticking 3-2 toward bottom roller 7-2. The purpose of guiding rollers 12 is to direct the peeled edge of ticking 3-2 towards the pins 9 of bottom roller 7-2 such that engagement between pins 9 and ticking 3-2 is maintained. This process is best illustrated in FIG. 12 in which the position of guiding roller 12 with respect to bottom peeling roller 7-2 is shown. Of course, it is to be appreciated that the size of the guiding roller 12 with respect to the bottom roller 7-2 is not drawn to scale in the illustration. In some embodiments, the diameter of guiding roller 12 may be relatively small with respect to the peeling rollers 7. In alternative embodiments, the diameter of guide roller 12 may be similar to the diameter of the peeling rollers 7. It will therefore be appreciated that a variety of guiding roller diameters is possible and that the illustrations are intended to illustrate the function of the components and are not indicative of the preferred proportions.

Still referring to FIG. 12, guiding rollers 12 exert a degree of pressure on the bottom ticking 3-2 in an upstream direction which increases engagement with pins 9. In particular embodiments, the guiding rollers 12 may be mounted to a tilting mechanism whereby the rollers can be tilted forwards to provide clearance as mattress 2 is fed between rollers 7. The guiding rollers 12 may then be tilted to another position as necessary during the ticking removal stage when the peeling roller 7 directions are reversed to facilitate removal of ticking from the rollers 7. As can be seen in FIG. 1, guiding rollers 12 are positioned between the pins 9 of bottom peeling roller 7-2 so as to avoid contact between guiding rollers 12 and pins 9. In some embodiments, the rollers may be formed by an elastic material such as rubber. Of course, it is to be appreciated that guiding rollers 12 are an ancillary component to the peeling station 14-5 and therefore, in some embodiments of the present invention may not be necessary and therefore may not be present. Similarly, in alternative embodiments, top guiding rollers (not shown) may be included adjacent to top roller 7-1 to facilitate the removal of top ticking 3-1.

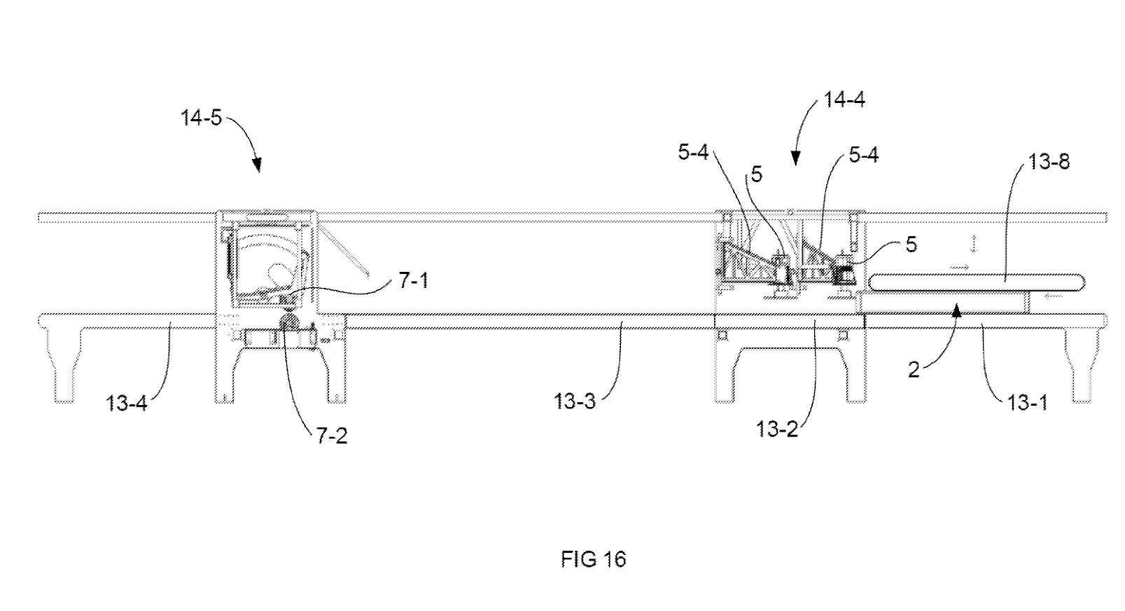

An example of a guiding roller tilt mechanism is illustrated in FIG. 13. Guiding rollers 12 are rotatably mounted to a guiding roller bracket 12-3 which is pivotally mounted to peeling station side frame 15. As illustrated in FIG. 13, an actuator 12-1 is mounted, at one end, to guiding roller bracket 12-3 and, at the other end, to peeling station side frame 15. It will therefore be appreciated that guiding roller actuator 12-1 is operable to tilt the guiding roller bracket 12-3 thereby shifting the position of guiding rollers 12 toward or away from bottom peeling roller 7-2.

Having described above the independent pin extension/retraction mechanism and also the operation of guiding rollers 12, reference is again made to FIG. 12 in which a particular embodiment of the invention is illustrated. In particular, FIG. 12 illustrates an arrangement whereby the guiding roller 12 and the independently retractable pins cooperate to remove bottom ticking 3-2 from mattress core 4 and direct the peeled ticking toward a receiving conveyer 13-7 positioned beneath the bottom roller 7-2. In some embodiments receiving conveyor 13-7 may lead to a cotton baler 14-6 as illustrated in FIG. 5.

As illustrated in FIG. 12, mattress 2 is conveyed between top roller 7-1 and bottom roller 7-2 in the conveyance direction. Top ticking 3-1 and bottom ticking 3-2 are engaged and peeled away from mattress core 4 by pins 9 of the top and bottom peeling rollers 7-1, 7-2 respectively. During the peeling stage, the pins 9 of top peeling roller 7-1 are maintained in the extended position until the ticking is completely removed from mattress core 4 and the ticking disengagement stage commences to ‘unwrap’ top ticking 3-1 from top peeling roller 7-1.

In contrast to the constant pin extension of top roller 7-1, the pins 9a-9e of the bottom peeling roller 7-2 are sequentially retracted and extended during the peeling stage to cooperate with guiding roller 12 thereby facilitating the bottom ticking 3-2 being directed towards receiving conveyor 13-7. As illustrated in FIG. 12, at the top of bottom peeling roller 7-2, the bottom ticking 3-2 will initially engage with an extended pin 9a at a general 12 o'clock position on bottom roller 7-2. At a generally 2 o'clock position, the next pin 9b, is also in an extended position and continues to peel bottom ticking 3-2 away from mattress core 4. Continuing in a clockwise direction around the circumference of bottom roller 7-2. At a generally 4 o'clock position, the bottom ticking 3-2 passes between guiding roller 12 and bottom roller 7-2. At a generally 5 o'clock position, pin 9c has passed guiding roller 12 and is now moved to a retracted position by a corresponding pin actuator 9-1. The retraction of pin 9c at this point of rotation disengages the bottom ticking 3-2 from bottom peeling roller 7-2. At this point on the circumference of bottom roller 7-2, bottom ticking 3-2 is separated from bottom roller 7-2 and is directed by guiding roller 12 towards receiving conveyor 13-7 below. At a generally 7 o'clock position, pin 9d is retained in a retracted position. At a generally 10 o'clock position, pin 9e is moved to an extended position ready for further engagement with a new section of bottom ticking 3-2 when it returns to the 12 o'clock position. It will therefore be appreciated that the independent movement of pins around the circumference of at least one peeling roller 7 can operate to selectively engage and disengage with mattress ticking at particular sections of the roller circumference.

In other embodiments of the peeling station 14-5, there is provided an adjustment mechanism 10 to adjust the position of top roller 7-1 relative to the position of bottom roller 7-2. In this regard, the spacing between the pair of peeling rollers 7 can be altered as necessary for improved engagement with mattresses of particular dimensions. As illustrated in FIG. 1, adjustment mechanism 10 includes a controllable actuator 10-1 mounted to the frame of the peeling station 14-5. Actuator 10-1 is operable to depress a first arm of linkage 10-3 which has a rotatable mounting 10-4. On the other side of rotatable mounting 10-3 is a second arm of linkage 10-3 to which one end of top roller 7-1 is rotatably mounted thereto and extending through a top roller adjustment slot 10-5. The distal end, opposite to controllable actuator 10-1, of linkage 10-3 is connected to a cross-bar 11 which extends through a cross-bar adjustment slot 10-6 and overhead the top roller 7-1 to the corresponding adjustment mechanism 10 on the other side of the cutting station 14-5. As will be appreciated with reference to FIG. 1, cross bar 11 is linked to the adjustment mechanism 10 on each end of the top roller 7-1 and thereby synchronises movement at each end of the top roller 7-1. It will therefore be appreciated that depression of the first arm of linkage 10-3 by actuators 10-1 in a downwards direction will operate to pivot the linkage 10-3 about rotatable mounting 10-4 thereby raising the second arm of linkage 10-3 and thereby raising the top roller 7-1 mounted thereto. Top roller 7-1 will thusly move in an upward direction following the path of top roller adjustment slot 10-5. Similarly, cross-bar 11 will move in a likewise fashion following the path of cross-bar adjustment slot 10-6. In this manner, the height of the top roller 7-1 relative to the bottom roller 7-2 may be adjusted and therefore the spacing between the pair of rollers 7 may be adjusted to receive mattresses 2 of various thicknesses.

In certain embodiments of the invention, the peeling station 14-5 may (in addition or as an alternative to the top roller adjustment mechanism) include a mechanism for adjusting the position of the bottom roller 7-2. In a particular form, a manually operable hand crank may be provided which operates a lead screw and thereby moving the bottom roller up/down relative to the top roller 7-1 and/or the peeling station feed conveyor 13-3. In this regard, the bottom roller could be adjusted to push, in an upwardly direction, against the underside of the mattress 2 and bottom ticking 3-2 to improve engagement of the pins 9 in bottom roller 7-2 with the bottom ticking 3-2. Of course, it will be appreciated that a manual adjustment mechanism such as this may also be applied to the top roller 7-1 in lieu of the automatic adjustment mechanism described above. Similarly, the automatic adjustment mechanism discussed above may equally be fitted to adjust the position of the bottom roller 7-3.

A particular embodiment of the above-described manually operable bottom roller adjustment mechanism is illustrated in FIG. 13. Bottom peeling roller 7-2 is positioned in bottom roller adjustment slot 10-7 and is rotatably connected to mounting 7-3. A pair of threaded members 7-4 extends from the bottom of mounting 7-3 and through corresponding swivel nuts 7-6 which are rotatably mounted to the peeling station side frame 15 via a bearing or another appropriate rotatable mounting. To manually adjust the position of bottom roller 7-2, swivel nuts 7-6 may be rotated, for example using a spanner or wrench, to thereby raise or lower threaded members 7-4 which are in threaded engagement with swivel nuts 7-6. In this way, rotatable mounting 7-3 may be raised or lowered and the position of bottom roller 7-2 may be shifted within bottom roller adjustment slot 10-7 to optimise the engagement of bottom roller 7-2 with mattress 2.

In a particular embodiment of the invention and illustrated in FIG. 1, the cutting station 14-5 includes a sensor 10-2 for determining positional and/or dimensional data of mattress 2. In a particular embodiment, the information captured by sensor 10-2 is applied by an automatic adjustment mechanism to adjust the position of at least one of the peeling rollers 7 according to the position and/or dimensions of the oncoming mattress 2 as it is conveyed toward the peeling rollers 7. In the illustrated embodiment, the sensor 10-2 is an ultrasonic sensor. In certain embodiments, the data determined by sensor 10-2 may be provided to a controller or suitable processing system which will be readily appreciable by a person skilled in the art. In one example, the dimensional data may be fed to a control system associated with the controllable actuator 10-1 and, in this manner, the position of top roller 7-1 may be adjusted to suit, for example, the thickness of the oncoming mattress 2. Of course, it will be appreciated that various alternatives to this system are within the scope of the invention and may include alternative sensors, control systems and adjustment mechanisms.

A further ancillary feature of the present invention relates to the cutting station 14-4 and is illustrated in FIG. 8. It will be appreciated that the forces applied to the mattress 2 as it is driven through cutting arms 5-4 may, in some cases, be sufficient to shift the position of the mattresses as it rests on cutting station conveyor 13-2. Whilst not critical to the performance of the disassembly apparatus 1, significant mattress movement can potentially affect the consistency of the cuts 6 applied by saws 5, corner saws 5-7 as well as detrimentally affect the engagement between the mattress ticking and the peeling roller pins 9. To this end, particular embodiments of the invention, as is illustrated FIG. 8, may include a cutting station conveyor 13-2 that is fitted with friction projections 13-5 to increase the friction between the underside of mattress 2 (e.g. bottom ticking 3-2) and the surface of the cutting station conveyor 13-2. In alternative forms, conveyor 13-2 may, instead, be fitted with friction pads or a series of friction spikes. It will be appreciated that any elements or pattern of conveyor belt 13-2 capable of increasing friction and thereby resisting movement of mattress 2 relative to conveyor 13-2 are within the scope of the invention.

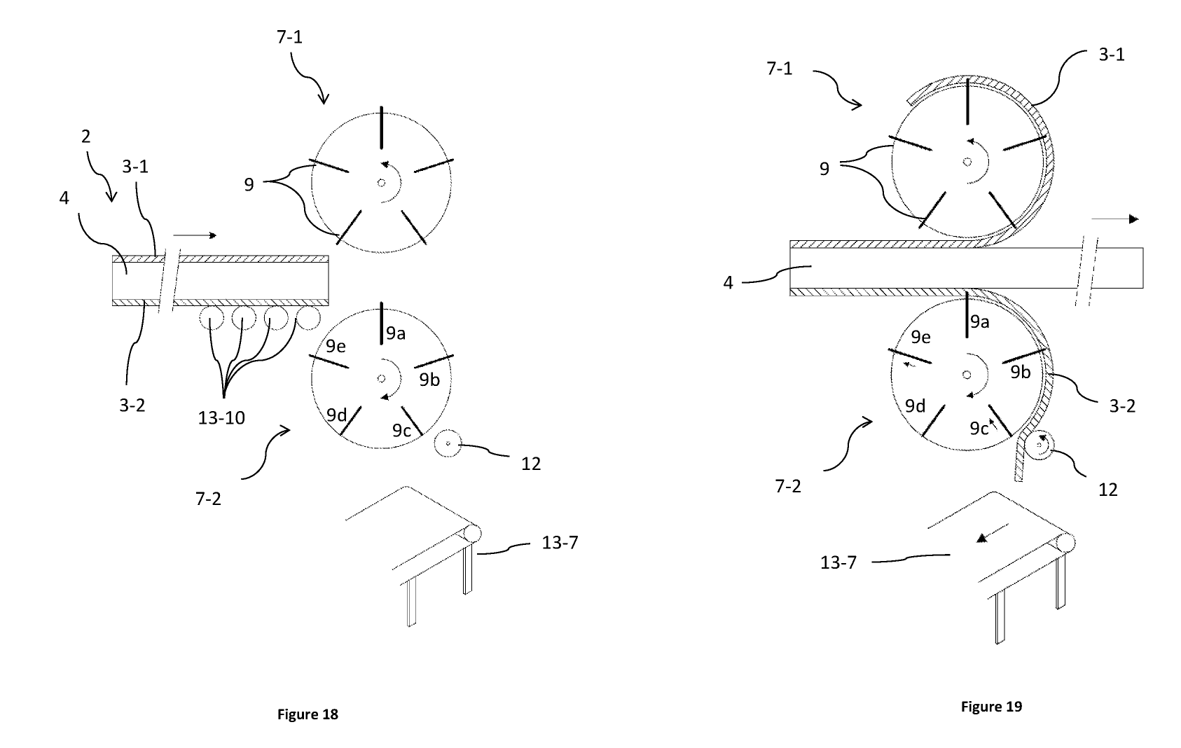

In another embodiment, an alternative or additional means to resist mattress movement during cutting station 14-4 is illustrated in FIG. 15. In this embodiment, top rollers 13-6 are located above mattress 2 and positioned so as to contact the upper surface of mattress 2 (e.g. top ticking 3-1) and exert a downwards pressure on mattress 2 thereby increasing friction with cutting station conveyor 13-2 and adding further resistance to mattress movement caused by the influence of cutting arms 5-4 and the associated saws 5. In the illustrated embodiment the top rollers 13-6 are mounted to support arms 13-9 however it will be appreciate that the top rollers 13-6 could be supported in a variety of alternative arrangements.

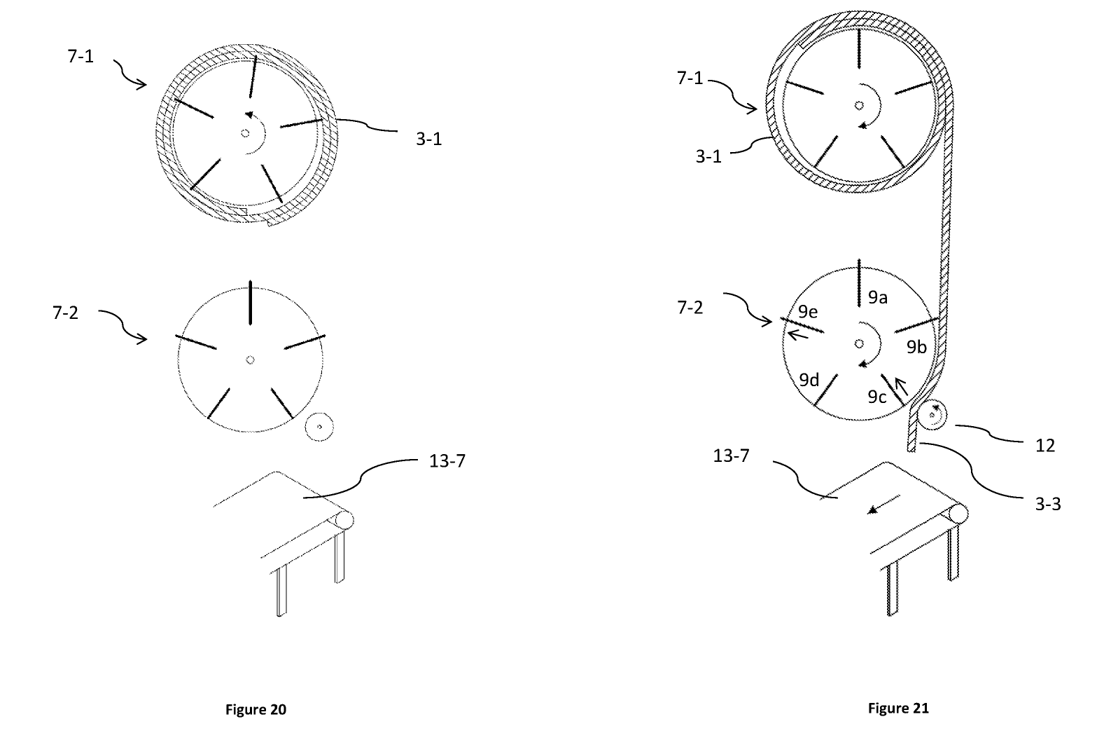

FIG. 16 illustrates an alternative embodiment to the arrangement shown in FIG. 15, in which a top conveyor 13-8 is positioned above the cutting station feed conveyor 13-1 to add additional resistance to mattress 2 movement caused by the influence of cutting arms 5-4 and saws 5 during the cutting stage. Top conveyor 13-8 is arranged generally parallel and spaced apart from cutting station feed conveyor 13-1. In this embodiment, mattress 2 is conveyed between the opposing conveyors 13-1, 13-8 and is therefore retained against movement by friction upon the top ticking 3-1 from the top conveyor 13-8 in addition to friction from the cutting station feed conveyor 13-1 on the bottom ticking 3-2. As will be appreciated with reference to FIG. 16, mattress 2 will pass from cutting station feed conveyor 13-1 to cutting station conveyor 13-2 and into contact with saws 5. As mattress 2 is conveyed through the cutting station 14-4, a portion of the upstream side of mattress 2 is still positioned between top conveyor 13-8 and cutting station feed conveyor 13-1 thereby retaining mattress 2 against movement from the forces applied to the perimeter surfaces of mattress 2 in the cutting station 14-4.

To accommodate mattresses of various sizes, in some embodiments the position of top rollers 13-6 or the top conveyor 13-8 is adjustable with respect to the cutting station conveyor 13-2. In particular forms of the invention, the adjustment mechanism is automated such that the top rollers 13-6 or top conveyor 13-8 is automatically adjusted to contact the top ticking 3-1 of mattress 2 according to dimensional information of the mattress 2 which is collected by ultrasonic sensor 10-2 or by another appropriate device such as a mechanical limit switch.

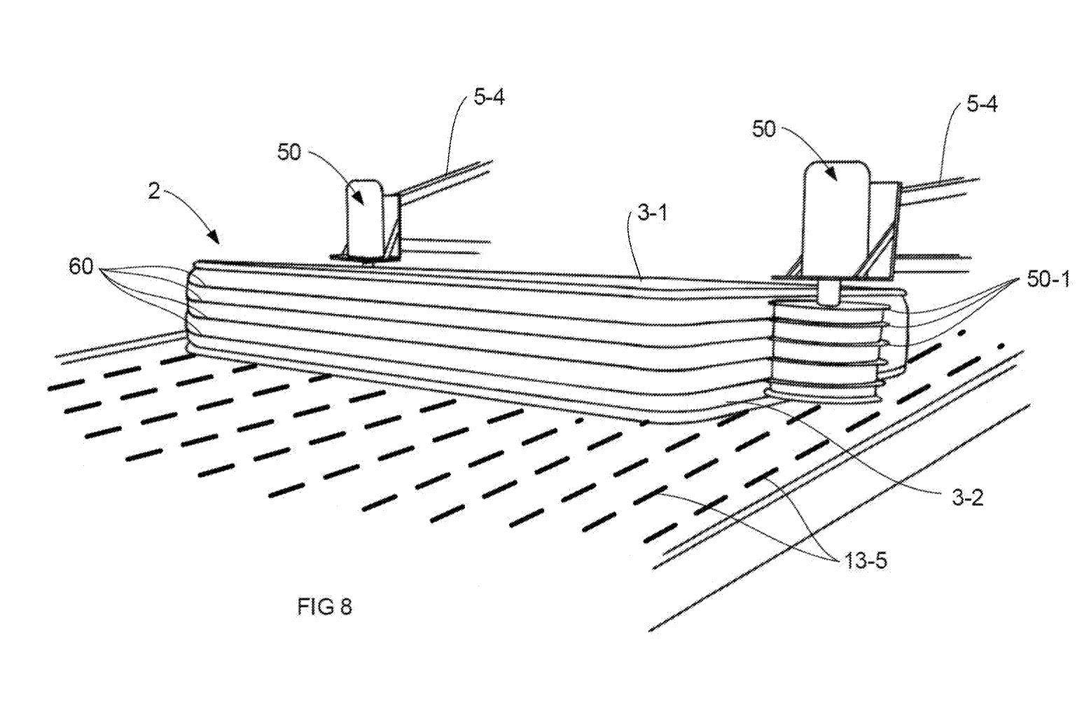

In a still further alternative to the embodiments discussed above, FIG. 6 illustrates an alternative to the embodiment illustrated in FIG. 3 wherein straight pins 9 have been replaced with curved pins 90. This alteration is directed at improving engagement between the peeling rollers 7 and the mattress ticking. To this end, pins 90 are provided with a slight curve in a circumferential direction so as to point in the direction of roller rotation when the mattress 2 is fed through peeling rollers 7. It will therefore be appreciated that FIG. 6 illustrates either bottom roller 7-2 viewed from a downstream perspective, alternatively, FIG. 6 illustrates top roller 7-1 viewed from an upstream perspective. Curved pins 90 are particularly advantageous in that curved pins tend to ‘bite’ the mattress surface by virtue of curve pins 90 penetrating with a small component of lateral direction into the mattress ticking. The result being that ticking is more securely engaged to the peeling surface 7-5 of peeling rollers 7 and less likely to slip off the pins as they rotate away from the mattress core 4. In another alternative (not shown) the pins may straight in the same manner as pins 9 but are angled in the direction of peeling roller 7 rotation during the peeling stage.

By way of further example, an operation sequence according to a particular embodiment of the invention is as follows. In a first stage of the process, the incoming mattress 2 is conveyed until its presence is detected by a mattress height detection sensor 10-2. After detection, the height (i.e. the distance between top and bottom surfaces) is measured and this information provided to an adjustment mechanism 10 operable to adjust the height of top roller 7-2 accordingly. The height detection sensor 10-2 will continue to detect the presence of mattress 2 until the mattress 2 has passed by the height detection sensor 10-2 at which point a timer will be triggered until the mattress 2 can be assumed to have passed through the peeling rollers 8 and therefore the ticking disengagement stage can commence.

Referring firstly to the operation of the top roller 7-1, the top roller 7-1 will begin to turn after the height of the mattress has been detected and measured. Pins 9 in the top roller 7-1 will then extend at least partially before engagement with the mattress surface and will remain in this position until direction of the top roller 7-1 is reversed in the ticking disengagement stage. After a particular time delay measurable from when the height detection device detects that the mattress has passed by the detection device, the pins 9 in the top roller 7-1 are moved to their retracted position. The ticking disengagement stage is thusly commenced and the top roller 7-1 reverses direction which will tend to transfer the top ticking 3-1 in a downwards direction between the bottom roller 7-2 and the guiding rollers 12.

Referring now to the operation of the bottom roller 7-2, as with the top roller 7-1, the bottom roller 7-2 will begin to turn after the height of the mattress 2 has been detected and measured (either manually or by a sensor device as discussed above). The pins 9 of the bottom roller 7-2 are then at least partially extended and the position of the guiding rollers 12 are adjusted towards the bottom roller 7-2 so as to contact or be in close proximity with the peeling surface 7-5 of the bottom peeling roller 7-2. The bottom ticking 3-2 is subsequently engaged by pins 9 of the bottom peeling roller 7-2 and pulled downwards by pins 9 between the guiding rollers 12 and the bottom peeling roller 7-2. As illustrated in FIG. 12, at the point of rotation where the pins 9 of the bottom roller 7-2 have rotated passed the guiding rollers 12, the bottom ticking 3-2 may be sufficiently controlled by the guiding roller 12 such that the pins 9 of the bottom roller 7-2 which have passed the guiding rollers 12 can move to the retracted position. The retracted pins which have passed guiding roller 12 are subsequently disengaged from bottom ticking 3-2 as they rotate around towards the engagement point between bottom roller 7-2 and mattress 2. Prior to arriving at the engagement point, the retracted pins 9 are re-extended ready for engagement with a further section of bottom ticking 3-2. The bottom roller 7-2 then continues to rotate until the mattress 2 has passed through the height detection and, after a time delay, the mattress is assumed by the system to have passed through the peeling rollers and the ticking disengagement stage can commence with the guiding rollers 12 moving to their original position, thereby providing clearance for ticking to be removed from the bottom roller 7-2. Of course, the above operational sequence is just one non-limiting example of an apparatus according to the present invention and it will be appreciated that alternative sequences may be applied that are within the scope of the invention. In alternative embodiments, the pins of both the top and bottom peeling rollers may be retracted at a particular point of rotation in order to facilitate disengagement with the ticking respectively engaged to each peeling roller.

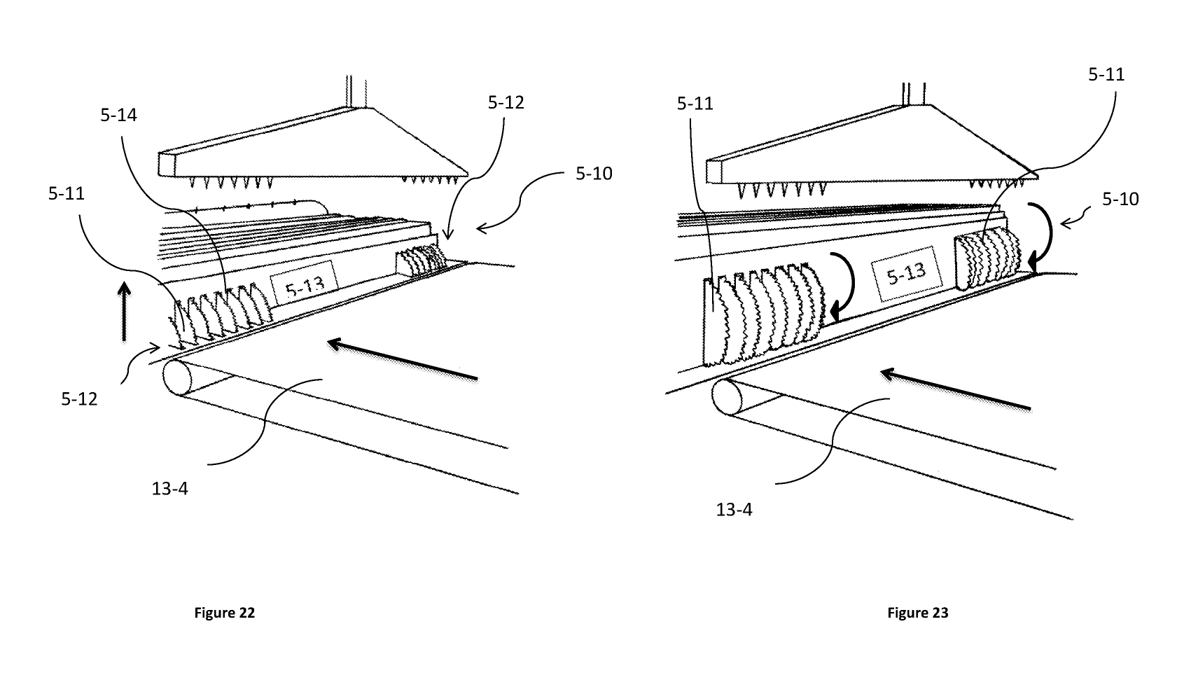

To better illustrate the peeling procedure illustrated in FIG. 12 and discussed above, FIG. 17 provides a perspective view of the peeling rollers illustrated via the diagram of FIG. 12. FIG. 17 illustrates a moment in the peeling sequence that is contemporaneous with FIG. 12, however, for illustrative purposes, a mattress is not shown in FIG. 17 in order that the position of pins 9 not be obscured. As illustrated in FIG. 17, pins 9 of top roller 7-1 are each extended to facilitate the engagement and winding of top ticking 3-1 around the peeling surface 7-5 of top roller 7-1. FIG. 17 is illustrated from the opposite perspective as compared to FIG. 12 and therefore, as indicated by the arrows in FIG. 17, the rotation of top roller 7-1, in FIG. 17 is clockwise and the rotation of bottom roller 7-2 is anticlockwise.

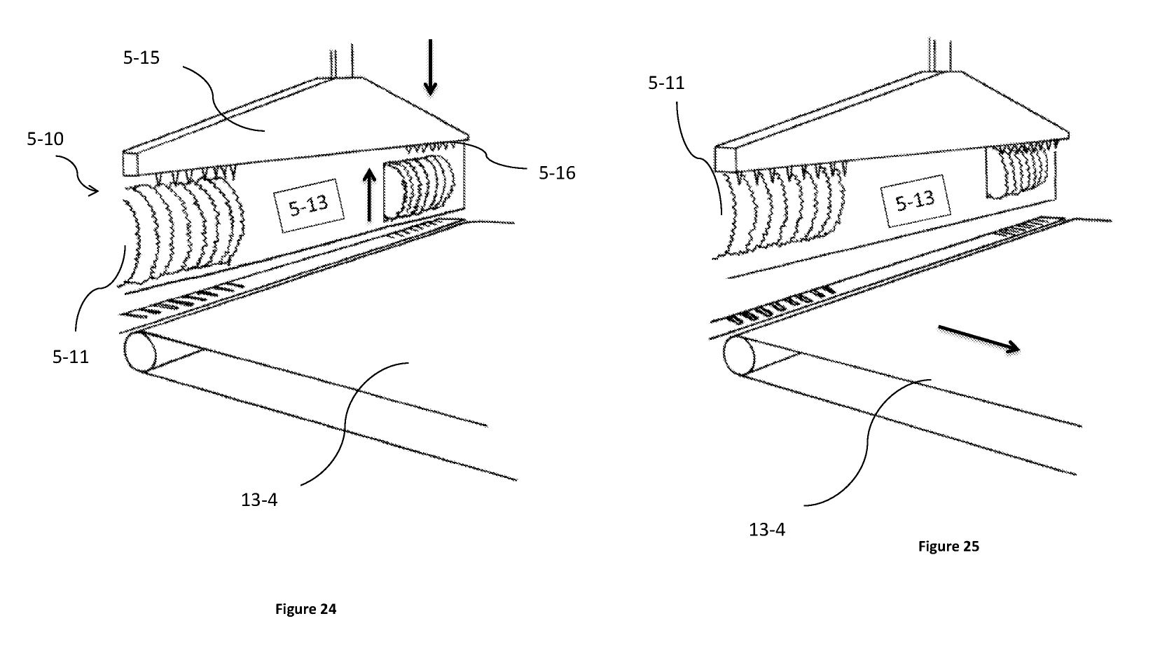

FIG. 12 illustrates a side view of pins 9a-9e which, in FIG. 17, each corresponds to a respective row of pins 9. As illustrated in FIG. 17, the row of pins 9a are fully extended for engagement the bottom mattress ticking. The row of pins 9b is still extended in order to pulling the ticking downward, away from the mattress core. Pin row 9c is illustrated having just rotated past guide rollers 12 and therefore pins 9c have retracted in order to disengage from the ticking and allow the ticking to be deposited beneath the bottom roller 7-2. Pin row 9c will remain retracted until approximately reaching the position of pin row 9e whereupon the pins are will re-extend prior to contact with the bottom ticking. It will therefore be appreciated that this sequence allows for the bottom ticking to be peeled from the mattress core and simultaneously deposited beneath the bottom roller 7-2. In contrast, the top ticking is wrapped around top roller 7-1 which necessitates top ticking removal stage which will be described with reference to FIGS. 18 to 21 in further detail.

Turning now to FIGS. 18 to 21, another side perspective of a peeling sequence is provided to better illustrate the movement of the ticking 3-1, 3-2 once peeled from the mattress core 4.

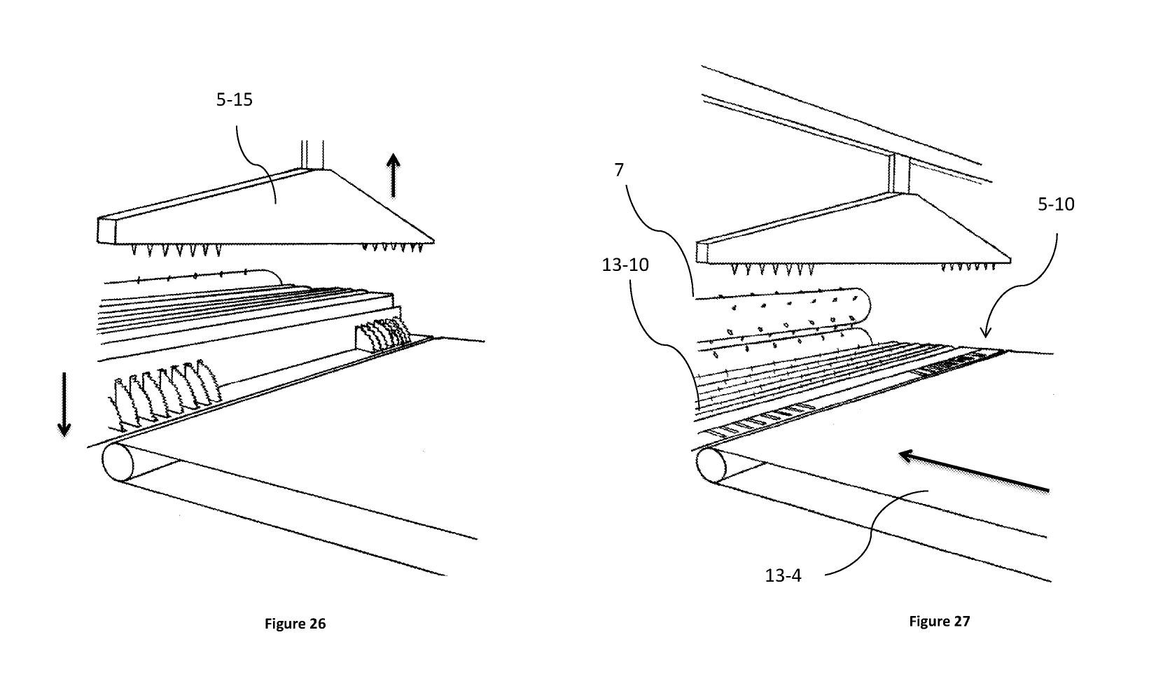

FIG. 18 illustrates a mattress 2 being conveyed along a plurality of conveyor rollers 13-10 which will be discussed in further detail below in relation to FIGS. 22 to 27. As illustrated in FIG. 18, mattress 2 is conveyed between the top roller 7-1 and the bottom roller 7-2. As discussed above in relation to FIG. 17, all pins on top roller 7-1 are extended while only pins 9e, 9a and 9b are extended in the bottom roller 7-2.

FIG. 19 mirrors the peeling process illustrated in FIG. 12 whereby the top ticking 3-1 is wound about top roller 7-1 and the bottom ticking 3-2 is partially engaged by the bottom roller 7-2 before being disengaged after passing between the bottom roller 7-2 and the guide rollers 12. Once rotated beyond the guide roller 12, pins 9c retract into the bottom roller 7-2 disengaging the bottom ticking 3-2 which then drops, under the influence of gravity, toward a receiving conveyor 13-7.

During peeling of the ticking, it will be appreciated that the top ticking 3-1 is wound about the top roller 7-1 and that the wrapped ticking 3-1 will increase its radial thickness with each rotation of the top roller 7-1. For this reason, in some embodiments of the present invention the invention, the top roller adjustment mechanism 10 (as illustrated in FIG. 1 and discussed above) will be operated during peeling in order to gradually raise the position of the top roller 7-1 relative to the bottom roller 7-2. Advantageously, this provides additional clearance for the increasing thickness of top ticking 3-1 wound about the top roller 7-1 and reduces the chance of a jam or obstruction occurring during the peeling process.

FIG. 20 illustrates the next stage of the peeling sequence once mattress 2 has completely passed through the peeling rollers 7. As illustrated, top ticking 3-1 is wound about top roller 7-1 whilst the bottom ticking has been already deposited and removed by receiving conveyor 13-7.

In the final stage of the sequence, as illustrated in FIG. 21, the pins 9 of top roller 7-1 are each retracted. Top roller 7-1 then reverses its rotation and begins to rotate in a removal direction to ‘unwind’ the top ticking 3-1 from the top roller 7-1. Meanwhile, the bottom roller 7-2 continues its rotation and pin movement sequence from the peeling stage illustrated in FIG. 19 (i.e. pins at 9e extending, pins at 9a and 9b remaining extended and pins at 9c being retracted). Under the influence of gravity, the free end 3-3 of the top ticking 3-1 falls downward and contacts the bottom roller 7-2 at, or adjacent to, the position of extended pins 9a or 9b. The top ticking 3-1 is therefore engaged by the extended pins 9 of the bottom roller 7-2 and is pulled downward between the bottom roller 7-2 and the guide rollers 12. In the same manner as the bottom ticking 3-2, the top ticking 3-1 is subsequently deposited on the receiving conveyor 13-7 by the retraction of bottom roller pins 9c which operates to disengage the bottom roller 7-2 from the top ticking 3-1. In this manner, the top ticking 3-2 is removed from the peeling rollers 7 and conveyed elsewhere for recycling, for example to a cotton baler 14-6 as illustrated in FIG. 5.

Turning now to FIGS. 22 to 27 there is illustrated an alternative embodiment of the present invention wherein a plurality of thickness cuts are applied to the downstream perimeter surface of the mattress by a thickness cutter 5-10 located between the cutting station 14-4 and the peeling station 14-5. As illustrated in FIG. 7, mattress 4 exits cutting station 14-4 with a plurality of horizontal cuts 60 having been applied to one of the side surfaces 2-1. In this embodiment, a thickness cutter 5-10 is configured to then apply a plurality of vertical thickness cuts to the perimeter surface.

Thickness cutter 5-10 may be provided in addition or as an alternative to the corner cutters 5-6 illustrated in FIG. 14. As discussed in the foregoing, the vertical corner cuts 5-9 are applied in order to relieve tension or tautness running longitudinally along the perimeter surface. Thickness cutter 5-10 addresses the same problem however, in contrast to the corner cutter 5-6; thickness cutter 5-10 applies a plurality of vertical cuts between the corners of the mattress as opposed to cuts 5-9 which are applied at the corners.

FIG. 22 illustrates a first stage of the thickness cutting process in which thickness cutter feed conveyor 13-4 is conveyed downstream, away from the cutting station (not shown) and toward thickness cutter 5-10. It will be appreciated that in some embodiments of the invention, thickness cutter feed conveyor 13-4 will be the same as the above-described peeling station feed conveyor 13-3 however for the purpose of describing FIGS. 22 to 27, this conveyor will be herein referred to as the thickness cutter 13-4. For illustrative purposes, a mattress will not be illustrated in the FIGS. 22 to 27 so as not to obscure the function of thickness cutter 5-10.

Whilst being conveyed along thickness cutter feed conveyor 13-4, an overhead sensor (not shown) identifies that a leading edge of a mattress has arrived at the location of the sensor and communicates with a controller (not shown) which triggers operation of the thickness cutter 5-10. The sensor also determines the thickness of the mattress, by calculating the distance from the sensor to the top ticking and deducting this value from the distance between the sensor and the conveyor 13-4. Upon activation by the controller, thickness cutter 5-10 is elevated upward by an elevation adjustment mechanism (not shown) from beneath the level of conveyor 13-4 to expose a plurality of vertically orientated cutting discs 5-11, each having a plurality of circumferentially distributed cutting teeth. Each cutting disc 5-11 extends through a respective opening 5-14 in a planar debris shield 5-13. The cutting discs 5-11 are arranged in a pair of cutting groups 5-12 disposed at either end of the thickness cutter 5-10. Cutting discs 5-11 are coaxially mounted to an axle (not shown) concealed behind the debris shield 5-13. In this regard, the portion of each cutting disc 5-11 defines a cutting portion configured for cutting engagement with the mattress. In this regard, debris shield 5-13 shields the internal componentry of the thickness cutter 5-10 from textile debris generated during the cutting process. During elevation of the thickness cutter 5-10, conveyor 13-4 continues to convey the mattress forward, toward the thickness cutter 5-10.

FIG. 23 illustrates a second stage of the thickness cutting process wherein thickness cutter 5-10 has been elevated from its retracted position to a lower cutting position by the elevation adjustment mechanism. Cutting discs 5-11 commence rotation in a clockwise direction (when viewed from the perspective in FIG. 23). In other words, the cutting teeth on the cutting portions projecting through openings 5-14 are travelling downwards. Conveyor 13-4 continues to convey the mattress until the downstream perimeter surface of the mattress is brought into contact with cutting discs 5-11 which apply a plurality of generally vertical cuts to the perimeter surface, along in the thickness direction of the mattress.

FIG. 24 illustrates the third stage of the thickness cutting process in which thickness cutter 5-10 is elevated further upward to an upper cutting position by the elevation adjustment mechanism in order to extend the length of the thickness cuts. In this regard, the thickness cuts will commence in a position generally at or adjacent to the bottom ticking (as shown in FIG. 23) and are then extended upward toward the top ticking. Immediately prior to the upward movement of the thickness cutter 5-10 from the lower cutting position to the upper cutting position, an overhead barrier member 5-15 is moved downward toward the cutting discs 5-11. Barrier member 5-15 comprises an elongated underside surface having a plurality of downwardly-facing projections 5-16 extending therefrom. Based on the mattress thickness information determined by the sensor (and communicated to the controller) barrier member 5-15 is moved downward to a predetermined position above the perimeter surface. Immediately thereafter, the thickness cutter 5-10 is elevated upward by a predetermined amount in order to extend the length of the thickness cuts. The extent to which the thickness cutter 5-10 moves upward is also dependent upon the mattress thickness identified by the sensor. Barrier member 5-15 operates to limit or restrict upward movement of the mattress in the event that upward movement of the thickness cutter 5-10 causes the mattress to be lifted upward. In the event that the elevation of cutting discs 5-11 causes the mattress to be raised off the conveyor 13-4, the top ticking abuts the elongated underside surface of the barrier member 5-15 such that the mattress is barred from any further upward movement. To ensure the edge of the mattress cannot slip from the elongated underside surface of the barrier member, projections 5-16 penetrate the top ticking to retain the mattress against lateral movement.

FIG. 25 illustrates a fourth stage of the thickness cutting process. Once the thickness cutter 5-10 has been elevated to its upper cutting position and the vertical thickness cuts have been applied from the bottom ticking to the top ticking, conveyor 13-4 briefly reverses direction, conveying the mattress upstream and separating the downstream perimeter surface from the cutting discs 5-11.

FIG. 26 illustrates a fifth stage of the thickness cutting process. Once the mattress has been conveyed a short distance away from the cutting discs 5-11, the thickness cutter is then retracted from its upper cutting position to its retracted position beneath the level of the conveyor 13-4. Concurrently, barrier member 5-15 is retracted upward to its original position.

FIG. 27 illustrates a sixth and final stage of the thickness cutting process in which the thickness cutter 5-10 has been moved to its retracted position beneath the level of the conveyor 13-4. Atop the thickness cutter 5-10 is a plurality of conveying rollers 13-10 each having a plurality of gripping projections extending outward from their outer surface. Conveying rollers 13-10 are driven to rotate by a driving arrangement (not shown) and thereby operate to convey the mattress between the end of the conveyor 13-4 and the peeling rollers 7. In this regard, the conveying rollers (also illustrated in FIG. 18) convey the mattress over the top of the retracted thickness cutter 5-10 and into the peeling station 14-5 which is located downstream of the thickness cutter 5-10.

The inclusion of a thickness cutter 5-10 between the lengthwise cutting station 14-4 and the peeling station 14-5 results in the downstream perimeter surface entering the peeling station 14-5 with a plurality of both vertical and horizontal cuts which form a ‘criss-cross’ or ‘grid’ pattern. Advantageously, this additional cutting further reduces tension in the mattress quilting resulting in improved engagement between the pins 9 of the peeling rollers 7 and the mattress ticking 3-1, 3-2. It will be appreciated that, in alternative embodiments, the thickness cutter could be arranged upstream of the lengthwise cutting station such that the thickness cuts are applied to the mattress before the lengthwise cuts.

It will also be appreciated that whilst the shape of peeling rollers 7 in the illustrated embodiment is cylindrical, references herein to terms such as ‘roller’ or ‘circumference’ do not limit the scope of the invention to cylindrical rollers. In other forms of the invention, peeling roller 7 cross section may be elliptical, octagonal or any other shape suitable to perform the peeling function of the peeling rollers 7.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

The invention described herein is susceptible to variations, modifications and/or additions other than those specifically described and it is to be understood that the invention includes all such variations, modifications and/or additions which fall within the spirit and scope of the present disclosure.

1. An apparatus to disassemble a mattress, the mattress including a mattress core between a top ticking and a bottom ticking and the mattress having perimeter surfaces comprising a pair of opposing side surfaces extending in a longitudinal direction and a pair of opposing end surfaces extending between the opposing side surfaces, the apparatus including:
a cutting arrangement for applying at least one cut along a length of at least one of the perimeter surfaces; and
at least one peeling roller having a peeling surface with retractable pins for engaging with the top and/or bottom ticking, the retractable pins being movable between a retracted position and an extended position
wherein the at least one peeling roller is rotatable in a peeling direction for peeling the top and/or bottom ticking from the mattress with the pins in the extended position and wherein the at least one peeling roller is rotatable in a removal direction, opposite to the peeling direction, for removing the peeled ticking from the peeling surface with the pins in the retracted position.

2. An apparatus according to claim 1 wherein the peeling roller includes a plurality of pin actuators to actuate movement of the pins between the extended and retracted positions, each pin actuator being associated with at least one pin.

3. An apparatus according to claim 2 wherein the plurality of pin actuators are independently operable to facilitate movement of pins on a section of the peeling surface that is independent from movement of pins on a separate section of the peeling surface.

4. An apparatus according to claim 1, including a top peeling roller for removing the top ticking of the mattress and a bottom peeling roller for removing the bottom ticking of the mattress, the bottom peeling roller including a plurality of independently operable pin actuators facilitating movement of pins on a section of the bottom roller peeling surface that is independent from movement of the pins on a separate section of the bottom peeling roller peeling surface.

5. An apparatus according to claim 4 wherein each of the top and bottom peeling rollers are rotatable in a peeling direction for peeling the top and bottom ticking from the mattress respectively, the top peeling roller being rotatable in a removal direction opposite to the peeling direction for removing the peeled ticking from the top peeling roller peeling surface with the top roller pins in the retracted position and wherein the independent pin movement of the bottom roller facilitates the bottom peeling roller and the bottom ticking engaging at a first section of the bottom peeling roller peeling surface and concurrently disengaging at a second section of the bottom peeling roller peeling surface.

6. An apparatus according to claim 5 wherein the pins on the bottom peeling roller are configured to extend on one side of the bottom peeling roller and to concurrently retract at approximately the opposite side of the bottom peeling roller.

7. An apparatus according to claim 1 wherein the cutting arrangement includes a saw having a plurality of cutting elements.

8. An apparatus according to claim 5 wherein the plurality of cutting elements are axially spaced apart.

9. An apparatus according to claim 7 wherein the saw includes a rotatable axle and wherein the cutting elements are cutting blades mounted to the rotatable axle.

10. An apparatus according to claim 5 including a pair of saws arranged to cooperatively apply a cut along a length of the at least one perimeter surface.

11. An apparatus according to claim 1, wherein the position of the at least one peeling roller is adjustable and wherein the apparatus includes a sensor and a controllable actuator to adjust the position of the at least one peeling roller into an engagement position based on the position and/or dimensions of the mattress determined by the sensor.

12. An apparatus according to claim 11 wherein the sensor is an ultrasonic distance sensor.

13. A method of disassembling a mattress, the mattress including a mattress core between a top ticking and a bottom ticking and the mattress having a perimeter comprising a pair of opposing side surfaces extending in a longitudinal direction and a pair of opposing end surfaces extending between the opposing side surfaces, the method including:
applying at least one cut along a length of at least one of the perimeter surfaces;
feeding the mattress, in a cut-first orientation, into at least one rotating peeling roller, the at least one peeling roller having a peeling surface with retractable pins movable between a retracted position and an extended position;
moving the pins of the at least one peeling roller to their extended position during the feeding of the mattress into the at least one peeling roller to engage and remove at least one of the top or bottom ticking of the mattress; and
moving the pins of the at least one peeling roller to their retracted position and reversing the direction of rotation of the at least one peeling roller to disengage the ticking from the at least one peeling roller for subsequent removal.

14. A method according to claim 13, wherein the mattress is fed between a top peeling roller and a bottom peeling roller to remove the top and bottom ticking of a mattress respectively.

15. A method according to claim 14 wherein during rotation of the bottom peeling roller, the movement of pins toward a retracted or an extended position occurs separately on a first section of the bottom roller peeling surface from the movement of the pins on a second section of the bottom roller peeling surface.

16. A method according to claim 14, including the steps of: moving a longitudinal row of pins on the bottom peeling to engage with a portion of the bottom ticking; rotating the bottom roller in a peeling direction to peel the portion of bottom ticking from the mattress core; moving the longitudinal row of pins to their retracted position to disengage with the portion of the bottom ticking.

17. A method according to claim 13, wherein during feeding of the mattress, at least some of the pins are moved so as to extend partially between their retracted position and their extended position.

18. A method according to claim 13, wherein the at least one cut is applied by a cutting arrangement, the method further including the steps of:
using a sensor to determine the position and/or dimensions of the mattress; and
adjusting the position of the at least one peeling roller and/or the position of the cutting arrangement based on the determined position and/or dimensions of the mattress.

19. A method of disassembling a mattress, the mattress including a mattress core between a top ticking and a bottom ticking and the mattress having a perimeter comprising a pair of opposing side surfaces extending in a longitudinal direction and a pair of opposing end surfaces extending between the opposing side surfaces, the method including:
applying at least one cut along a length of at least one of the perimeter surfaces;
feeding the mattress, in a cut-first orientation, between a pair of top and bottom rotating peeling rollers, the peeling rollers each having a peeling surface with retractable pins movable between a retracted position and an extended position;
moving the pins of the top roller to their extended position to engage and remove the top ticking of the mattress, the top ticking being subsequently wound about the top roller;
executing a pin movement sequence in the pins of the bottom roller wherein a row of pins of the bottom roller move to their extended position prior to contact with the bottom ticking, to engage and remove a portion of the bottom ticking and wherein the row of pins subsequently return to their retracted position after contact and peeling of the ticking portion to permit disengagement between the bottom roller and the ticking portion and facilitate the deposit of the bottom ticking beneath the bottom roller; and
moving the pins of the top peeling roller to their retracted position and reversing the direction of the top roller to disengage and unwind the top ticking from the top roller.

20. A method according to claim 19, including the step of maintaining the rotation and pin movement sequence of the bottom roller during disengagement of the top ticking to facilitate engagement between the top ticking and the bottom roller and to deposit the top ticking beneath the bottom roller.
